(19) United States
(12) Patent Application Publication
(10) Pub. No.: US 2007/0140403 A1
(43) Pub. Date: Jun. 21, 2007

(54) Method for inspection and maintenance of an inside of a nuclear power reactor

(75) Inventors: Yasuhiro Yuguchi, Yokohama-Shi (JP); Hiroyuki Adachi, Tokyo (JP); Tetsuro Nakagawa, Yokohama-Shi (JP); Satoshi Yamamoto, Kawaguchi-Shi (JP); Hidefumi Amanai, Yokohama-Shi (JP); Ken Okuda, Yokohama-Shi (JP)

Correspondence Address: FOLEY AND LARDNER LLP;SUITE 500, 3000 K STREET NW, WASHINGTON, DC, 20007, US

(73) Assignee: KABUSHIKI KAISHA TOSHIBA

(21) Appl. No.: 11/504,691

(22) Filed: Aug. 16, 2006

(30) Foreign Application Priority Data
Aug. 24, 2005 (JP) 2005-242561

(51) Int. Cl. G21C 17/00

(52) U.S. Cl. 376/249

(57) ABSTRACT

A method for inspection and maintenance of an inside of a nuclear power reactor is provided, which can perform positioning of a remote operated vehicle relative to an inspection target surface in a nuclear power reactor in a short period of time with high accuracy, and enhance the positioning repeatability for the remote operated vehicle, thereby enabling performance of the inspection and maintenance for the inspection target surface securely and satisfactorily. For the inspection or maintenance for the inspection target surface 1a in a nuclear power reactor by using the remote operated vehicle 30, a detection mark 3 is formed in advance by providing a notching, marking, punching or engraving process to the inspection target surface 1a before performing inspection or maintenance of the inside of the nuclear power reactor by using the remote operated vehicle 30. Then, the remote operated vehicle 30 is driven to move in the nuclear power reactor filled with water. During the movement, the detection mark 3 formed in the inspection target surface 1a is detected by using the remote operated vehicle 30 so as to determine the position of the remote operated vehicle 30.

### BACKGROUND OF THE INVENTION

The present invention relates to a method for inspection and maintenance of an inside of a nuclear power reactor, in which an inspection and maintenance of an inside of a nuclear power reactor using a remote operated vehicle is performed, and in particular to a method in which positioning of a remote operated vehicle can be performed adequately.

Structures in a nuclear power reactor are formed of materials having satisfactory endurance under a high-temperature and high-pressure environment and good strength at high temperature, for example, austenite stainless steel or nickel alloys.

Among structures in a nuclear power reactor, members or parts which are difficult to replace tend to be exposed to a severe environment because of a long-term operation of the plant. In addition, by adverse affect of neutron irradiation, deterioration of the materials tends to occur.

In particular, in the vicinity of welded portions of a shroud for structures in a nuclear power reactor, tendency of materials to be sensitive to some reactions due to heat of welding or influence of remaining tensile stress may lead to potential stress corrosion cracking.

Therefore, such structures in a nuclear power reactor should be periodically inspected, maintained and repaired. Additionally, prior to the inspection or repair, cleaning and washing (e.g. brushing) are provided to keep the surface condition of the structures clean in a nuclear power reactor.

Conventionally, in order to perform an inspection for structures in a nuclear power reactor, a remote operated vehicle, as disclosed in JP2005-30773A, JP2003-40194A, JP9-58586A and JP10-273095A, is employed. Such a remote operated vehicle comprises thrusters (propellers) adapted to drive the water moving instrument toward an inspection target surface (or surface to be inspected), running wheels adapted to travel on the inspection target surface when the remote operated vehicle is pressed against the inspection target surface, and inspection sensors for inspecting the inspection target surface.

In general, upon inspection or maintenance for an inspection target surface of a structure in a reactor using a remote operated vehicle, a method, in which a worker approaches a location to be inspected and then carries out measurement on an inspection target surface using a scale, is employed to recognize a position of an inspection or maintenance for the inspection target surface.

However, in the case where it is difficult for a worker to access an inspection target surface, for example, in a nuclear power reactor, the worker should use a method of disposing a remote operated vehicle at any given reference structure provided in or on the inspection target surface in the nuclear power reactor and deriving the position of the inspection target surface from mechanical dimensions in the remote operated vehicle, a method of providing a plurality of driving joints, such as a robot arm, to a remote operated vehicle and calculating each driving position of these joints, or a method of measuring relative distances by three-dimensional or stereoscopic observation for the same target using a plurality of cameras (Association, Nippon Gensiryoku-gakkai (Meeting of Autumn in 2001) H-48: Development of a three-dimensional position standardizing technology by stereoscopic observation using cameras for underwater visual inspection).

Specifically, in the conventional method for inspection and maintenance of an inside of a nuclear power reactor, upon determining the position of a remote operated vehicle, an articulated arm and a camera are used for measuring the position of the remote operated vehicle and dimensions of a target to be inspected. Furthermore, upon actually determining the position of the remote operated vehicle, the position of a distal portion of the arm is calculated from displacement of the respective joints of the arm relative to the reference structure in the nuclear power reactor, and three-dimensional sizes are grasped by a stereoscopic observation using the camera.

### SUMMARY OF THE INVENTION

Problem to be Solved by the Invention

However, in the aforementioned conventional positioning methods, since an articulated arm is used, the positioning system must be in a large scale, thus taking much time to determine the position of the remote operated vehicle. In addition, the access range in which it is possible to use the arm is limited.

The present invention was made to address the above problems, and therefore, it is an object thereof to provide a method for inspection and maintenance of an inside of a nuclear power reactor, which can perform positioning of a remote operated vehicle relative to an inspection target surface in a nuclear power reactor in a short period of time with high accuracy, and enhance the positioning repeatability for the remote operated vehicle, thereby providing secure and satisfactory inspection and maintenance for the inspection target surface.

Means for Solving the Problem

The present invention is a method for inspection and maintenance of an inside of a nuclear power reactor, for performing inspection and maintenance for an inspection target surface in a nuclear power reactor, by using a remote operated vehicle, the method comprising the steps of:

forming a detection mark in advance by providing a notching, marking, punching or engraving process to the inspection target surface before performing inspection or maintenance of the inside of the nuclear power reactor by using the remote operated vehicle;

driving the remote operated vehicle to move in the nuclear power reactor filled with water; and

during the driving step of the remote operated vehicle, detecting the detection mark formed in the inspection target surface by using the remote operated vehicle so as to determine the position of the remote operated vehicle.

According to this method for inspection and maintenance of an inside of a nuclear power reactor, since the positioning of the remote operated vehicle can be performed utilizing the detection mark formed in advance in the inspection target surface, as a landmark, as compared with the case where the detection mark is not formed in the inspection target surface, the positioning of the remote operated vehicle relative to the inspection target surface in a nuclear power reactor can be performed in a short period of time with high accuracy, thereby enhancing the positioning repeatability for the remote operated vehicle.

In the method for inspection and maintenance of an inside of a nuclear power reactor, it is preferred that, in the step of forming the detection mark in advance, the notching, marking, punching or engraving process is provided to the inspection target surface by using an electric discharging machine, cutting machine, grinding machine, laser processing machine, electrolytic processing machine, carving machine or vibrating pen; and the method further comprising the step of collecting secondary products to be produced due to the above process.

According to this method for inspection and maintenance of an inside of a nuclear power reactor, since secondary products, such as metal dust, produced in the notching process or the like to the inspection target surface by a cutting machine or the like, can be collected while the detection mark is formed in advance, the formation of the detection mark can be performed not only during construction of a nuclear power reactor but also upon a refueling outage for the nuclear power reactor.

The present invention is a method for inspection and maintenance of an inside of a nuclear power reactor, for performing inspection and maintenance for an inspection target surface in a nuclear power reactor, by using a remote operated vehicle, the method comprising the steps of:

forming a detection mark in advance by attaching an attachment member to the inspection target surface before performing inspection or maintenance of the inside of the nuclear power reactor by using the remote operated vehicle;

driving the remote operated vehicle to move in the nuclear power reactor filled with water; and

during the driving step of the remote operated vehicle, detecting the detection mark formed in the inspection target surface by using the remote operated vehicle so as to determine the position of the remote operated vehicle.

According to this method for inspection and maintenance of an inside of a nuclear power reactor, since the positioning of the remote operated vehicle can be performed by utilizing the detection mark comprising the attachment members attached to the inspection target surface, as a landmark, as compared with the case where the attachment members are not attached to the inspection target surface, the positioning of the remote operated vehicle relative to the inspection target surface in a nuclear power reactor can be performed in a short period of time with high accuracy, thereby enhancing the positioning repeatability for the remote operated vehicle.

In the method for inspection and maintenance of an inside of a nuclear power reactor, it is preferred that, in the step of forming the detection mark in advance, a welded bead is formed as the detection mark.

According to this method for inspection and maintenance of an inside of a nuclear power reactor, the detection mark can be formed with ease by a simple method of providing a weld bead to the inspection target surface.

In the method for inspection and maintenance of an inside of a nuclear power reactor, it is preferred that, in the step of forming the detection mark in advance, the detection mark is formed such that it extends linearly along the direction in which the remote operated vehicle is to be moved when it performs inspection or maintenance for the inspection target surface.

What is meant by “extends linearly” is a situation in which the detection mark extends along the inspection target surface such that the detection mark would extend linearly in a development elevation in which the inspection target surface would be developed in a plane.

According to this method for inspection and maintenance of an inside of a nuclear power reactor, since the detection mark is formed such that it extends linearly, the positioning of the remote operated vehicle utilizing the detection mark as a landmark can be performed more securely and accurately.

In the method for inspection and maintenance of an inside of a nuclear power reactor, it is preferred that the linearly extending detection mark has also a function to guide the remote operated vehicle when it performs inspection or maintenance for the inspection target surface in the nuclear power reactor.

According to this method for inspection and maintenance of an inside of a nuclear power reactor, since the remote operated vehicle can be guided along the direction in which the detection mark extends, the positioning of the remote operated vehicle can be performed more securely and accurately.

In the method for inspection and maintenance of an inside of a nuclear power reactor, it is preferred that, after the step of forming the detection mark in advance, the method further comprises the step of providing surface finish and/or remaining stress reduction in advance to the detection mark formed in the inspection target surface.

According to this method for inspection and maintenance of an inside of a nuclear power reactor, occurrence of damage, such as stress corrosion cracking, in an inspection target site including the detection mark comprising notched portions or attachment members can be prevented.

In the method for inspection and maintenance of an inside of a nuclear power reactor, it is preferred that a detection sensor, composed of any one or combination of ones selected from the group consisting of a photographic device, an ultrasound distance sensor, a laser distance sensor, a ferrite scope, an ultrasonic testing equipments, an eddy current instrument and a mechanical contact switch, is provided in the remote operated vehicle, and that the detection mark is detected by the detection sensor.

According to this method for inspection and maintenance of an inside of a nuclear power reactor, by detecting the detection mark using the detection sensor, the remote operated vehicle can detect the detection mark formed in the inspection target surface more accurately, whereby the positioning of the remote operated vehicle relative to the inspection target surface in the nuclear power reactor can be performed with higher accuracy.

In the method for inspection and maintenance of an inside of a nuclear power reactor, it is preferred that the position of the remote operated vehicle is determined by: forming the detection mark, in the step of forming the detection mark in advance, the detection mark comprising a first detection mark portion extending along the direction in which the remote operated vehicle is to be moved when it performs inspection or maintenance for the inspection target surface, and a second detection mark portion which is different in shape and extending direction from those of the first detection mark portion; and detecting the second detection mark portion by using the remote operated vehicle moving in the direction in which the first detection mark portion extends when the remote operated vehicle performs inspection or maintenance for the inspection target surface.

According to this method for inspection and maintenance of an inside of a nuclear power reactor, since the positioning of the remote operated vehicle relative to the inspection target surface in the nuclear power reactor can be performed by driving the remote operated vehicle to move along the direction in which the first detection mark portion extends and detecting the second detection mark portion by using the remote operated vehicle, the positioning of the remote operated vehicle can be performed more accurately.

In the method for inspection and maintenance of an inside of a nuclear power reactor, it is preferred that the detection sensor is provided in large numbers to be arranged in directions different from the direction in which the remote operated vehicle is to be moved when it performs inspection or maintenance for the inspection target surface.

According to this method for inspection and maintenance of an inside of a nuclear power reactor, the detection range on the inspection target surface can be enlarged due to the detection sensors, whereby the detection of the detection mark can be performed in a short period of time with ease.

The present invention is a method for inspection and maintenance of an inside of a nuclear power reactor, for performing inspection and maintenance for an inspection target surface in a nuclear power reactor, by using a remote operated vehicle, the method comprising the steps of:

forming a detection mark in advance by providing a notching, marking, punching or engraving process to the inspection target surface before performing inspection or maintenance of the inside of the nuclear power reactor by using the remote operated vehicle;

driving the remote operated vehicle to move in the nuclear power reactor filled with water; and

during the movement of the remote operated vehicle, detecting the detection mark formed in the inspection target surface by using a photographic device provided separately from the remote operated vehicle so as to determine the position of the remote operated vehicle.

According to this method for inspection and maintenance of an inside of a nuclear power reactor, there is no need to provide a position measurement means in the remote operated vehicle due to the photographic device provided separately from the remote operated vehicle, and in particular, in the case where it is needed to make the remote operated vehicle access the inspection target surface to a great extent, the time required for the positioning can be reduced.

In the method for inspection and maintenance of an inside of a nuclear power reactor, it is preferred that the step of forming the detection mark in advance is performed in the air during construction of a nuclear power reactor, while performed in the water upon a refueling outage of an operating nuclear power reactor.

According to this method for inspection and maintenance of an inside of a nuclear power reactor, since exposure to radioactivity of a worker can be prevented upon a work of forming the detection mark, by forming it in the air during construction of a nuclear power reactor while forming it in the water upon a refueling outage of an operating nuclear reactor, the formation work of the detection mark can be performed safely and easily.

The present invention is a method for inspection and maintenance of an inside of a nuclear power reactor, for performing inspection and maintenance for an inspection target surface in a nuclear power reactor, by using a remote operated vehicle having a detection sensor, the method comprising the steps of:

cladding the inspection target surface as a detection mark in advance, which detection mark having a color different from the color of the inspection target surface, before performing inspection and maintenance of the inside of the nuclear power reactor by using the remote operated vehicle;

driving the remote operated vehicle to move in the nuclear power reactor filled with water; and

during the movement, detecting the detection mark coated in advance by using the detection sensor of the remote operated vehicle so as to determine the position of the remote operated vehicle.

According to this method for inspection and maintenance of an inside of a nuclear power reactor, since the positioning of the remote operated vehicle can be performed utilizing the detection mark coated in advance on the inspection target surface, as a landmark, as compared with the case where the detection mark is not coated on the inspection target surface, the positioning of the remote operated vehicle relative to the inspection target surface in a nuclear power reactor can be performed in a short period of time with high accuracy, thereby enhancing the positioning repeatability for the remote operated vehicle.

The present invention is a method for inspection and maintenance of an inside of a nuclear power reactor, for performing inspection and maintenance for an inspection target surface in a nuclear power reactor, by using a remote operated vehicle having a detection sensor, the method comprising the steps of:

attaching attachment members in advance to the inspection target surface, and further cladding the attachment members as a detection mark in advance, which detection mark having a color different from the color of the inspection target surface, before performing inspection and maintenance of the inside of the nuclear power reactor by using the remote operated vehicle;

driving the remote operated vehicle to move in the nuclear power reactor filled with water; and

during the movement, detecting the detection mark coated in advance by using the detection sensor of the remote operated vehicle so as to determine the position of the remote operated vehicle.

According to this method for inspection and maintenance of an inside of a nuclear power reactor, since the positioning of the remote operated vehicle can be performed, by utilizing the detection mark coated on the attachment members which are attached in advance to the inspection target surface, as a landmark, as compared with the case where the detection mark is not coated on the inspection target surface, the positioning of the remote operated vehicle relative to the inspection target surface in a nuclear power reactor can be performed in a short period of time with high accuracy, thereby enhancing the positioning repeatability for the remote operated vehicle.

In the method for inspection and maintenance of an inside of a nuclear power reactor, it is preferred that, in the step of cladding in advance, the detection mark is formed such that it extends linearly along the direction in which the remote operated vehicle is to be moved upon performing inspection or maintenance for the inspection target surface.

According to this method for inspection and maintenance of an inside of a nuclear power reactor, since the detection mark is formed to extend linearly, the positioning of the remote operated vehicle utilizing the detection mark as a landmark can be performed more securely with higher accuracy.

In the method for inspection and maintenance of an inside of a nuclear power reactor, it is preferred that the linearly extending detection mark has also a function to guide the remote operated vehicle when it performs inspection or maintenance for the inspection target surface in the nuclear power reactor.

According to this method for inspection and maintenance of an inside of a nuclear power reactor, since the remote operated vehicle is guided along the direction in which the detection mark extends, the positioning of the remote operated vehicle can be performed more securely with higher accuracy.

In the method for inspection and maintenance of an inside of a nuclear power reactor, it is preferred that the detection sensor of the remote operated vehicle is composed of any one or combination of ones selected from the group consisting of a photographic device, an ultrasound distance sensor, a laser distance sensor, a ferrite scope, an ultrasonic testing equipments, an eddy current instrument and a mechanical contact switch.

According to this method for inspection and maintenance of an inside of a nuclear power reactor, the remote operated vehicle can detect the detection mark formed on the inspection target surface more accurately, whereby the positioning of the remote operated vehicle relative to the inspection target surface in a nuclear power reactor can be performed with higher accuracy.

In the method for inspection and maintenance of an inside of a nuclear power reactor, it is preferred that, in the step of cladding as the detection mark in advance, a detection mark, comprising a first detection mark portion extending along the direction in which the remote operated vehicle is to be moved when it performs inspection or maintenance for the inspection target surface, and a second detection mark portion which is different in shape and extending direction from those of the first detection mark portion, is formed, and the second detection mark is detected by the detection sensor of the remote operated vehicle moving along the direction in which the first detection mark extends when the remote operated vehicle performs inspection and maintenance for the inspection target surface so as to perform the positioning of the remote operated vehicle.

According to this method for inspection and maintenance of an inside of a nuclear power reactor, since the positioning of the remote operated vehicle relative to the inspection target surface in the nuclear power reactor can be performed by driving the remote operated vehicle to move along the direction in which the first detection mark portion extends and detecting the second detection mark portion by using the remote operated vehicle, the positioning of the remote operated vehicle can be performed more accurately.

In the method for inspection and maintenance of an inside of a nuclear power reactor, it is preferred that the detection sensor is provided in large numbers to be arranged in directions different from the direction in which the remote operated vehicle is to be moved when it performs inspection or maintenance for the inspection target surface.

According to this method for inspection and maintenance of an inside of a nuclear power reactor, the detection range on the inspection target surface due to the detection sensors can be enlarged, whereby the detection of the detection mark can be performed in a short period of time with ease.

The present invention is a method for inspection and maintenance of an inside of a nuclear power reactor, for performing inspection and maintenance for an inspection target surface in a nuclear power reactor, by using a remote operated vehicle, the method comprising the steps of:

cladding the inspection target surface as a detection mark in advance, which detection mark having a color different from that of the inspection target surface, before performing inspection and maintenance of the inside of the nuclear power reactor by using the remote operated vehicle;

driving the remote operated vehicle to move in the nuclear power reactor filled with water; and

during the driving step of the remote operated vehicle, detecting the detection mark formed on the inspection target surface by using a photographic device provided separately from the remote operated vehicle so as to determine the position of the remote operated vehicle.

According to this method for inspection and maintenance of an inside of a nuclear power reactor, there is no need to provide a position measurement means in the remote operated vehicle due to the photographic device provided separately from the remote operated vehicle, and in particular, in the case where it is needed to make the remote operated vehicle access the inspection target surface to a great extent, the time required for the positioning can be reduced.

In the method for inspection and maintenance of an inside of a nuclear power reactor, it is preferred that the step of forming the detection mark in advance is performed in the air during construction of a nuclear power reactor, while performed in the water upon a refueling outage of an operating nuclear power reactor.

According to this method for inspection and maintenance of an inside of a nuclear power reactor, since exposure to radioactivity of a worker can be prevented upon a work of cladding as the detection mark, by forming it in the air during construction of a nuclear power reactor or otherwise forming it in the water upon a refueling outage of an operating nuclear reactor, the cladding work of the detection mark can be performed safely and easily.

Effect of the Invention

According to the method for inspection and maintenance of an inside of a nuclear power reactor, upon performing inspection or maintenance for an inspection target surface in a nuclear power reactor by using a remote operated vehicle, the positioning of the remote operated vehicle relative to the inspection target surface in the nuclear power reactor can be performed in a short period of time with high accuracy, and the positioning repeatability for the remote operated vehicle can be enhanced, thereby providing secure and satisfactory inspection and maintenance for the inspection target surface

### BRIEF DESCRIPTION OF THE DRAWINGS

FIG. 1 is a perspective view showing an outline of a method for inspection and maintenance of an inside of a nuclear power reactor according to a first embodiment of the present invention.

FIG. 2 is a perspective view showing a detection mark comprising recessed portions formed in an inspection target surface of a structure in a nuclear power reactor.

FIG. 3(a) is a cross section taken along line A-A of a recessed portion shown in FIG. 2, and FIG. 3(b) is a schematic view of the recessed portion of FIG. 2 when viewed along arrow B.

FIG. 4(a) is a cross section taken along line E-E of another recessed portion shown in FIG. 2, and FIG. 4(b) is a schematic view when viewed along arrow F shown with this recessed portion of FIG. 2.

FIG. 5 is an explanatory front view showing a detection mark comprising other recessed portions formed in an inspection target surface of a structure in a nuclear power reactor.

FIG. 6 is an explanatory front view showing a detection mark comprising still other recessed portions formed in an inspection target surface of a structure in a nuclear power reactor.

FIG. 7 is an explanatory front view showing a detection mark comprising still other recessed portions formed in an inspection target surface of a structure in a nuclear power reactor.

FIG. 8 is an explanatory front view showing a detection mark comprising still other recessed portions formed in an inspection target surface of a structure in a nuclear power reactor.

FIG. 9 is an explanatory front view showing a detection mark comprising still other recessed portions formed in an inspection target surface of a structure in a nuclear power reactor.

FIG. 10 is an explanatory perspective view showing a construction of an electric discharging machine for forming a detection mark comprising recessed portions in an inspection target surface.

FIG. 11 is a vertical cross section of the electric discharging machine of FIG. 10.

FIG. 12 is an explanatory perspective view showing a construction of a grinding machine for forming a detection mark comprising recessed portions in an inspection target surface.

FIG. 13 is vertical cross section of the grinding machine of FIG. 12.

FIG. 14 is an explanatory perspective view showing a construction of a carving machine for forming a detection mark comprising recessed portions in an inspection target surface.

FIG. 15 is a perspective view showing a construction of a remote operated vehicle according to the first embodiment.

FIG. 16 is vertical view showing a construction of a detection sensor provided in the remote operated vehicle of FIG. 15.

FIG. 17 is a perspective view showing a construction of another remote operated vehicle and a detection sensor according to the first embodiment.

FIG. 18 is a perspective view showing a construction of still another remote operated vehicle and a detection sensor according to the first embodiment.

FIG. 19 is a perspective view showing a construction of still another remote operated vehicle according to the first embodiment.

FIG. 20 is an explanatory perspective view showing a detection mark comprising recessed portions formed in an inspection target surface of a structure in a nuclear power reactor of a modification of the first embodiment.

FIG. 21 is a perspective view showing a construction of a detection sensor for detecting the detection mark shown in FIG. 20.

FIG. 22 is a perspective view showing an outline of a method for inspection and maintenance of an inside of a nuclear power reactor of a still another modification of the first embodiment.

FIG. 23 is a perspective view showing a construction of a remote operated vehicle according to a second embodiment of the present invention.

FIG. 24 is a perspective view showing a construction of a remote operated vehicle of a modification according to the second embodiment.

FIG. 25 is a perspective view showing an outline of a method for inspection and maintenance of an inside of a nuclear power reactor according to a third embodiment of the present invention.

FIG. 26 is a perspective view showing an outline of another method for inspection and maintenance of an inside of a nuclear power reactor according to the third embodiment of the present invention.

FIG. 27(a) is a front view of a recessed portion shown in FIG. 25, and FIG. 27(b) is a vertical cross section of the recessed portion.

FIG. 28(a) is a front view of recessed portions shown in FIG. 26, and FIG. 28(b) is a vertical cross section of the recessed portions when viewed along arrow A′-A′.

FIG. 29 is an explanatory front view showing a detection mark comprising still other recessed portions formed in an inspection target surface of a structure in a nuclear power reactor according to the third embodiment.

FIG. 30(a) is a front view showing a construction of a remote operated vehicle according to the third embodiment, and FIG. 30(b) is a vertical cross section of the remote operated vehicle.

FIG. 31(a) is a front view showing a construction of another remote operated vehicle according to the third embodiment, and FIG. 31(b) is a vertical cross section of the remote operated vehicle.

FIG. 32(a) is a front view showing a construction of still another remote operated vehicle according to the third embodiment, and FIG. 31(b) is a vertical cross section of the remote operated vehicle.

FIG. 33(a) is a perspective view for illustrating an outline of a method for inspection and maintenance of an inside of a nuclear power reactor according to a fourth embodiment of the present invention, and FIG. 33(b) is a vertical cross section of a rail shown in FIG. 33(a) when viewed along arrow C-C.

FIG. 34(a) is a perspective view for illustrating an outline of another method for inspection and maintenance of an inside of a nuclear power reactor according to the fourth embodiment of the present invention, and FIG. 34(b) is a vertical cross section of a rail and a remote operated vehicle shown in FIG. 34(a).

### DETAILED DESCRIPTION OF THE INVENTION

### EXAMPLES

### FIRST EMBODIMENT

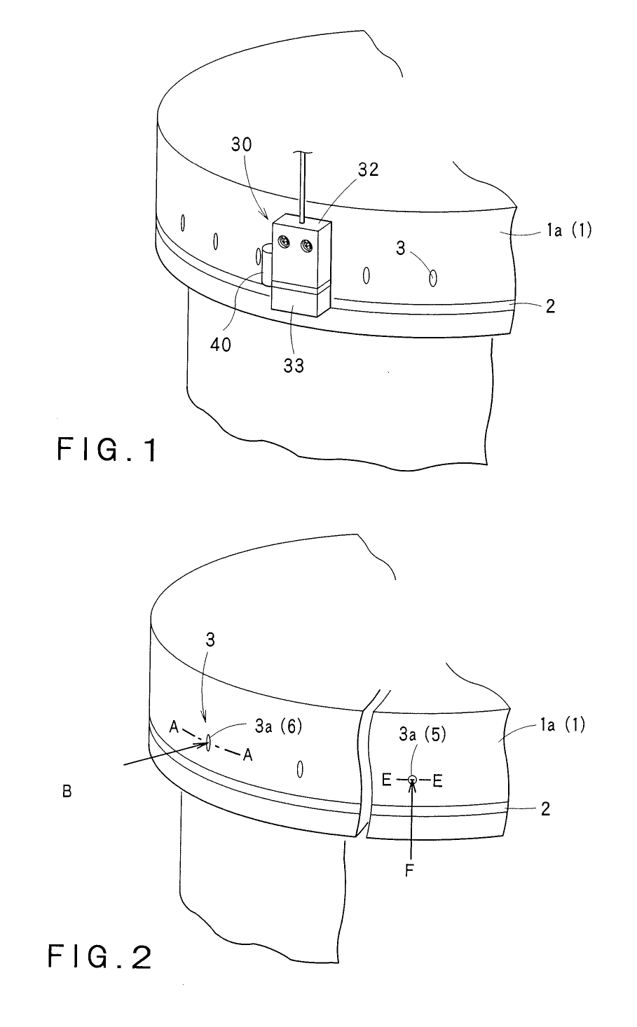

Hereinafter, a first embodiment according to the present invention will be described with reference to the drawings. FIGS. 1 through 22 show a method for inspection and maintenance of an inside of a nuclear power reactor of this embodiment, respectively.

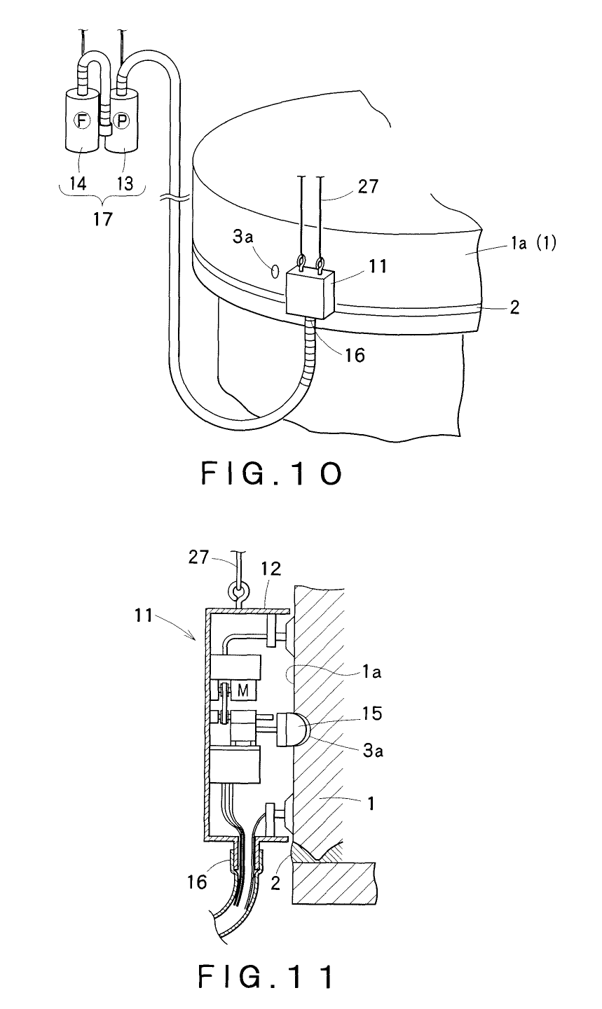

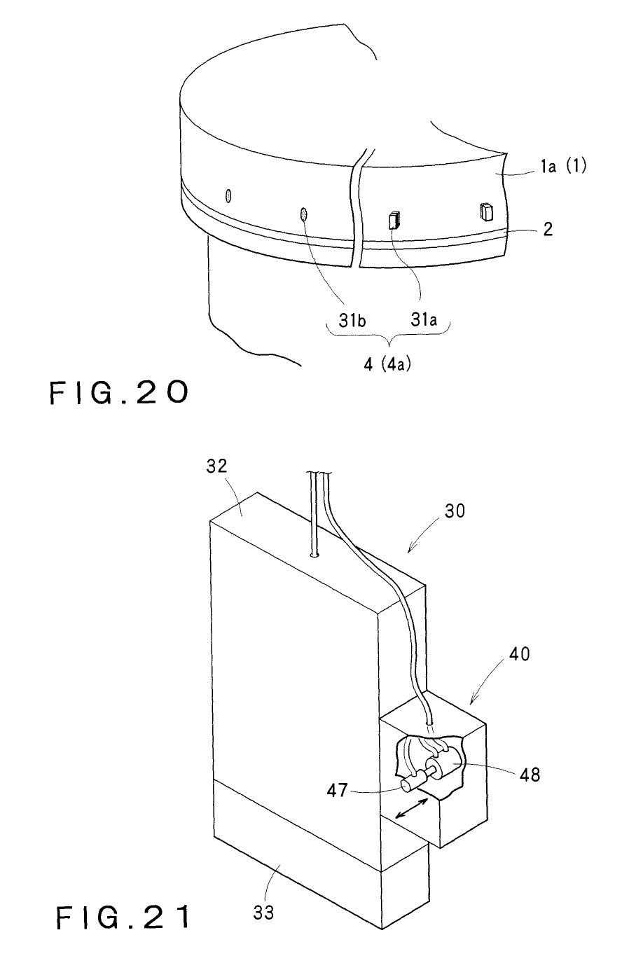

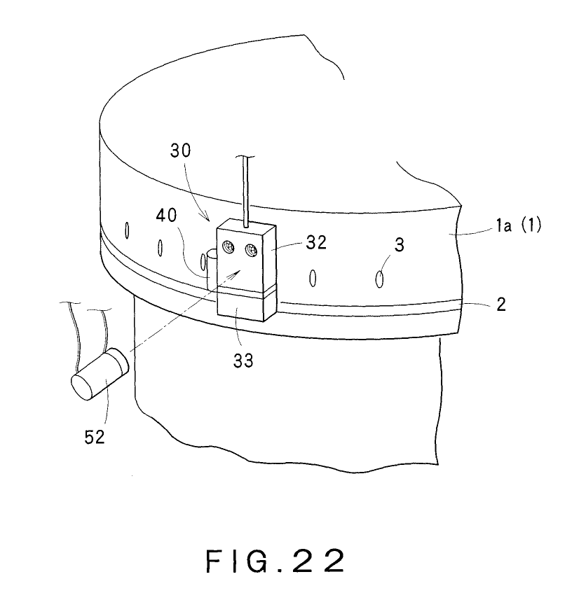

Among these drawings, FIG. 1 is a perspective view for illustrating an outline of the method for inspection and maintenance of an inside of a nuclear power reactor of this embodiment, FIGS. 2 to 9 are explanatory views each showing a detection mark comprising recessed portions formed in an inspection target surface of a structure in a nuclear power reactor. FIGS. 10 to 14 are explanatory views each showing a processing machine for forming a detection mark comprising recessed portions in an inspection target surface. FIGS. 15 to 19 are explanatory views each showing a construction of a remote operated vehicle and a detection sensor provided to the remote operated vehicle. FIG. 20 is an explanatory view showing a detection mark comprising attachment members formed in an inspection target surface of a structure in a nuclear power reactor, and FIGS. 21 and 22 are explanatory views each showing a construction of a detection sensor for detecting the detection mark of FIG. 20.

The method for inspection and maintenance of an inside of a nuclear power reactor of this embodiment is adapted to perform inspection or maintenance for an inspection target surface 1a of a structure 1 in a nuclear power reactor using a remote operated vehicle 30 (described below). Specifically, as shown in FIG. 1, before performing inspection or maintenance of an inside of a nuclear power reactor using the remote operated vehicle 30, a detection mark 3 have been formed in advance in the inspection target surface 1a of the structure in a nuclear power reactor. Upon actually performing the inspection or maintenance of the inside of the nuclear power reactor, the remote operated vehicle 30 is moved in the nuclear power reactor in which water is filled. During the movement, the detection mark 3 formed in the inspection target surface 1a are detected by a detection sensor 40 provided in the remote operated vehicle 30, thereby determining the position of the remote operated vehicle 30.

In this case, as the structure 1 in a nuclear power reactor which is the object to be inspected and/or maintained, a welded structure, such as a reactor core shroud, can be mentioned. However, other welded structures including nuclear power reactor pressure vessels or stainless-steel pool linings may be selected as the object to be inspected and/or maintained. Upon performing inspection or maintenance for a welded structure such as the structure 1 in a nuclear power reactor, the need for inspection, for example, in the vicinity of a welded portion 2 as shown in FIG. 1, has been increased. If some defect is detected by such inspection, repair is carried out by using the remote operated vehicle 30. Otherwise, if assessed that there may be some possibility of damage, a protective maintenance, such as reduction of remaining stress, is performed. Prior to inspection or repair, in order to keep the surface condition of the inspection target surface to be clean, the remote operated vehicle 30 is cleaned and washed. Such operation including inspection, repair, maintenance, washing, cleaning (e.g. brushing) and the like for the inspection target surface 1a in a nuclear power reactor is herein referred to as “performing inspection and/or maintenance.”

Now, each of the steps constituting the method for inspection and maintenance of an inside of a nuclear power reactor according to this embodiment will be described in detail.

(Step of Forming a Detection Mark)

First, a step of forming the detection mark 3 in advance in the inspection target surface 1a of the structure 1 in a nuclear power reactor, before performing inspection or maintenance of an inside a nuclear power reactor using the remote operated vehicle 30, is described with reference to FIGS. 2 through 14.

As shown in FIG. 2, during construction of a nuclear power reactor, the detection mark 3 comprising recessed portions 3a is formed, in the air, using a notching, marking, punching or engraving process, in the inspection target surface 1a of the structure 1 in a nuclear power reactor at a factory thereof. Otherwise, such a detection mark 3 comprising recessed portions 3a may be formed in the water upon a refueling outage for a nuclear power reactor on line.

The recessed portions 3a, as shown in FIG. 2, are formed in large numbers at an adequate interval in the vicinity of the welded portion 2 of the inspection target surface 1a. In the case of forming a detections mark comprising such recessed portions 3a in the inspection target surface 1a, an electric discharging machine 11, cutting machine, grinding machine 18, laser processing machine, electrolytic processing machine, carving machine 29 or vibrating pen can be used. These processing machines will be described later.

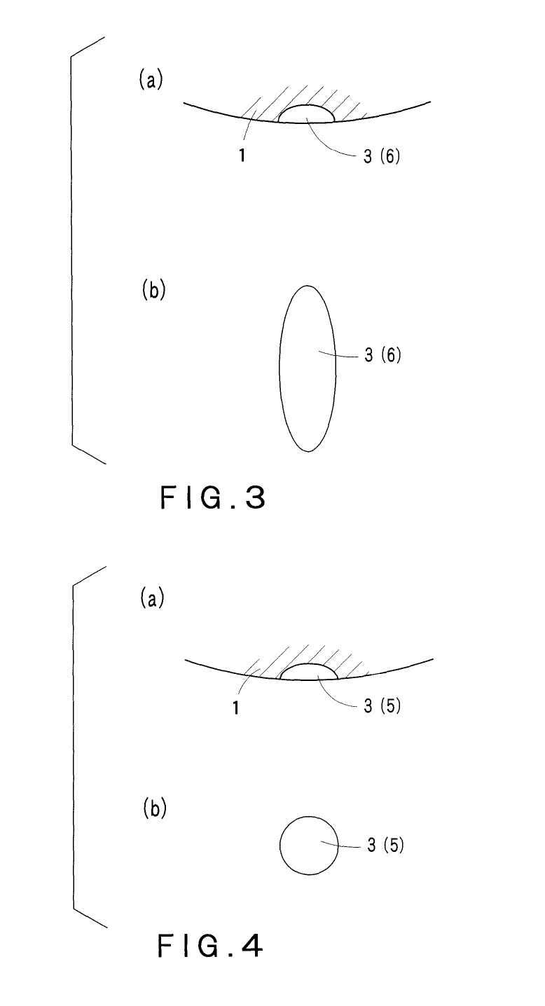

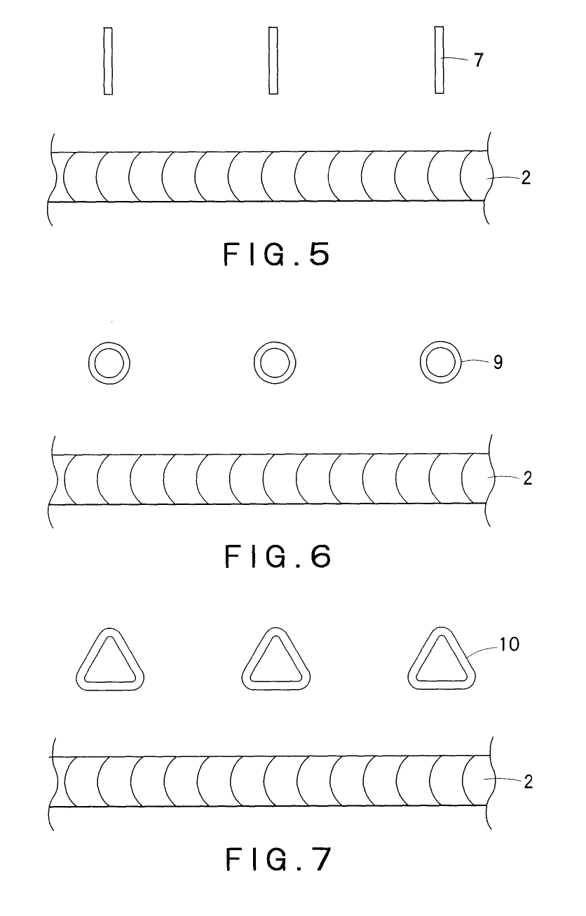

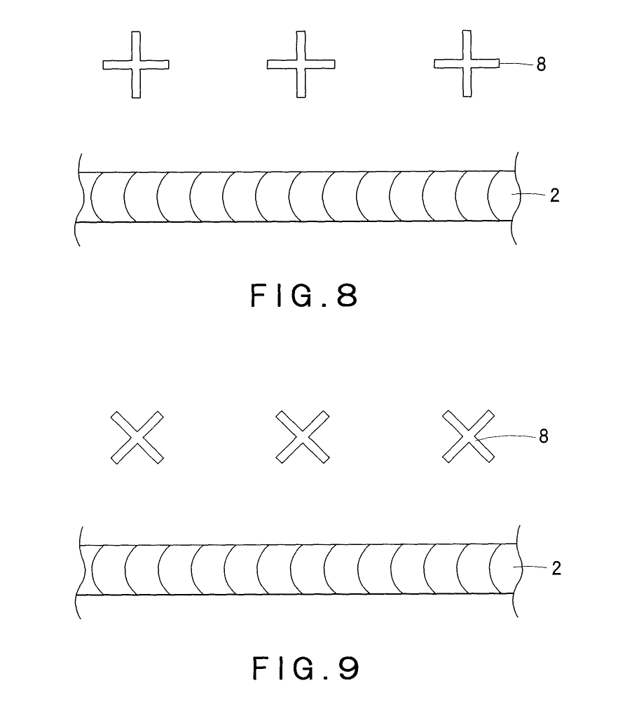

As the detection mark 3 comprising recessed portions 3a, those having various shapes can be mentioned. For example, semi-spherical recessed portions 6 each having an elliptic opening as shown in FIG. 3, semi-spherical recessed portions 5 each having a circular opening as shown in FIG. 4, linear recessed portions 7 as shown in FIG. 5, toric recessed portions 9 as shown in FIG. 6, generally triangular recessed portions 10 each apex of which being curved as shown in FIG. 7 or cross-shaped recessed portions 8 as shown in FIG. 8 or 9 may be formed as the detection mark 3 in the inspection target surface 1a in the vicinity of the welded portion 2 of the structure 1 in a nuclear power reactor. In the case of forming the recessed portions 3a in the air, among the above-described recessed portions, the semi-spherical recessed portions 5, 6 can be formed by using a cutting machine or grinding machine 18, while the linear or cross-shaped, i.e., grooved recessed portions 7, 8, 9, 10 can be formed by using a carving machine 29 or vibrating pen. On the other hand, in the case of forming the recessed portions 3a in the water, adding to the aforementioned cutting machine, grinding machine 18, carving machine 29 or vibrating pen, an electric discharging machine 11 or electrolytic processing machine is often used.

Now, the case where the detection mark 3 comprising recessed portions 3a is formed by a notching process using an electric discharging machine 11 is described with reference to FIGS. 10 and 11. FIG. 10 is a perspective view of the electric discharging machine 11, and FIG. 11 is a vertical cross section of the electric discharging machine 11 of FIG. 10. As shown in FIGS. 10 and 11, the electric discharging machine 11 includes an electric discharging portion 15 adapted to perform electrical discharge machining so as to form the recessed portions 3a in the inspection target surface 1a of the structure 1 in a nuclear power reactor, and a hood 12 for hermetically covering the electric discharging portion 15, the hood 12 being hung by wires 27 from above to be positioned. At the bottom surface of the hood 12, a suction port 16 is provided. A suction pump 13 and a filter 14 are connected with the suction port 16 via a connecting hose. In the case where the electric discharging portion 15 performs electrical discharge machining to the inspection target surface 1a and foreign matters (secondary products), such as metal dust, are thus produced, these foreign matters can be sucked by the suction pump 13 and trapped by the filter 14. Thus, the suction pump 13 and filter 14 constitute a secondary product collecting system 17 of the electric discharging machine 11.

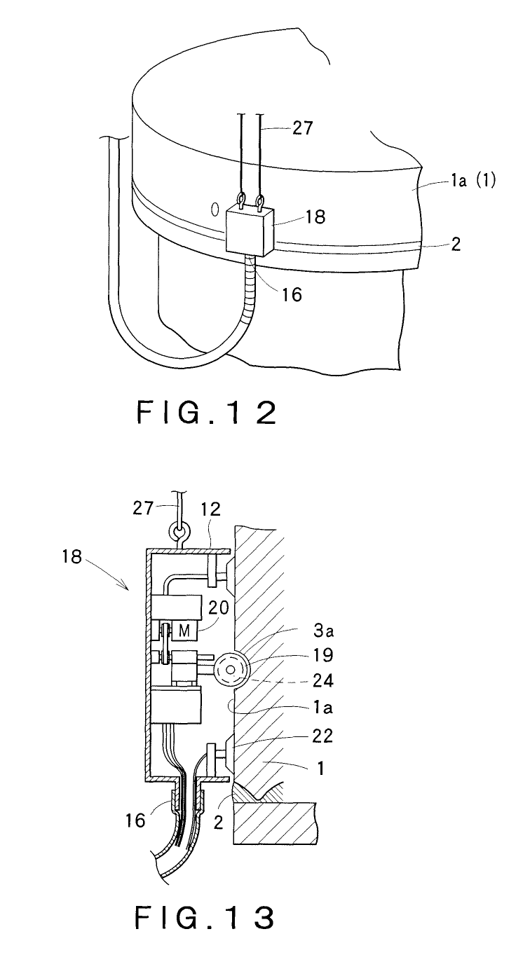

Next, the case where the detection mark 3 comprising recessed portions 3a is formed by another notching process using a grinding machine 18 (or cutting machine) is described with reference to FIGS. 12 and 13. FIG. 12 is a perspective view of the grinding machine 18, and FIG. 13 is a vertical cross section of the grinding machine 18 of FIG. 12. As shown in FIGS. 12 and 13, the grinding machine 18 includes a machining head 19 adapted to perform a grinding process so as to form the recessed portions 3a in the inspection target surface 1a of the structure 1 in a nuclear power reactor, a motor 24 adapted to rotate the machining head 19, a suction pad 22 for securing the grinding machine 18 itself to the inspection target surface 1a, a driving motor 20 for driving the machining head 19 to move in the vertical direction of FIG. 13, and a hood 12 for hermetically covering the machining head 19, the hood 12 being hung by wires from above to be positioned. At the bottom surface of the hood 12, a suction port 16 is provided, and a suction pump and a filter are connected with the suction port 16 through a connecting hose, constituting a secondary product collecting system (not shown), as in the case of the aforementioned electric discharging machine 11. Accordingly, in the case where the machining head 19 performs a grinding process to the inspection target surface 1a and foreign matters, such as metal dust, are thus produced, the foreign matters can be sucked by the suction pump and trapped by the filter.

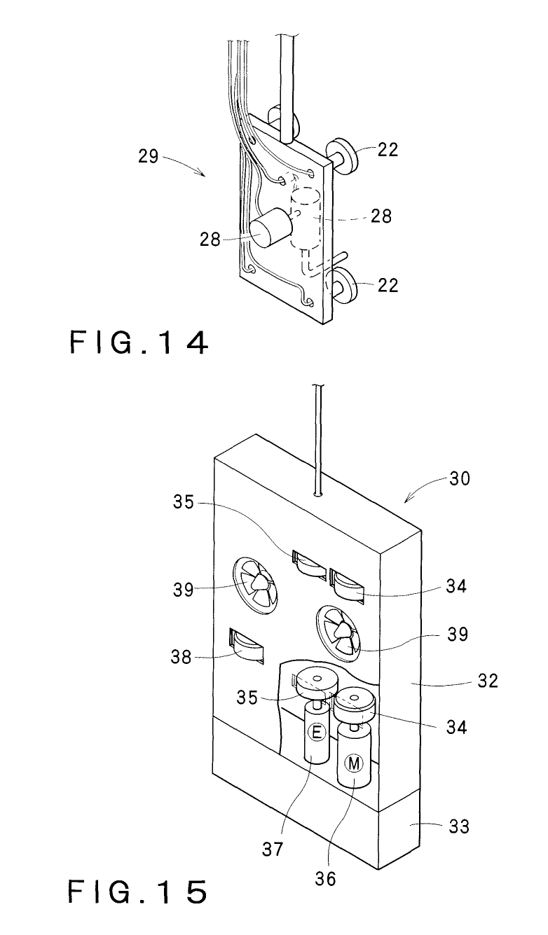

Further, the case where the detection mark 3 comprising recessed portions 3a is formed by a punching, marking or engraving process using a carving machine 29 is described with reference to FIG. 14. FIG. 14 is a perspective view of the carving machine 29. As shown in FIG. 14, the carving machine 29 includes a cylinder piston 28 adapted to perform a punching, marking or engraving process so as to from the recessed portion 3 in the inspection target surface 1a of the structure 1 in a nuclear power reactor, and a suction pad 22 for securing the marking machine 29 itself to the inspection target surface 1a.

With the construction as described above, either in the air or water, the detection mark 3 comprising recessed portions 3a is formed in advance by applying a notching, marking, punching or engraving process to the inspection target surface 1a. In this case, for the recessed portions 3a to be formed in the inspection target surface 1a, no occurrence of stress corrosion cracking is checked in advance by a material testing or the like. If occurrence of damage, such as stress corrosion cracking, is predicted for the recessed portions 3a, it is preferred to form the detection mark 3, comprising the semi-spherical recessed portions 6 each having an elliptic opening as shown in FIG. 3 or semi-spherical recessed portions 5 each having a circular opening as shown in FIG. 4, in the inspection target surface 1a to provide protective maintenance

At this time, if information concerning an absolute position of each site to be inspected is needed, the distance from a fixed point (or reference point) in the inspection target surface 1a to each recessed portion 3a is measured to determine the processing position. On the other hand, if only the positioning repeatability relative to the inspection target surface is needed, there is no need to measure the distance from a fixed point of the inspection target face 1a with respect to each recessed portion 3a.

In the case where the material of the structure 1 in a nuclear power reactor is austenite stainless steel, stress corrosion cracking may occur in the structure 1 in a nuclear power reactor by a formation work for the detection mark 3 or welding work for the welded portion 2. For this reason, as needed, a preventive measure, such as surface finish or reduction of remaining stress, is provided to the surface of each recessed portion 3a or an area in the vicinity of the welded portion 2. As the reduction of remaining stress, for example, the polishing, shot peening, water jet peening or laser peening can be mentioned.

(Step of Driving the Remote Operated Vehicle)

Next, a step of driving the remote operated vehicle 30 to move in a nuclear power reactor which is filled with water will be described with reference to FIG. 15. FIG. 15 is a perspective view of the remote operated vehicle 30.

First, the construction of the remote operated vehicle 30 is described with reference to the drawing.

As shown in FIG. 15, the remote operated vehicle 30 includes a positioning unit 32 adapted to determine the position of the remote operated vehicle 30, and a working head 33 fixedly secured to the bottom surface of the positioning unit 32 and adapted to perform a necessary work to the inspection target surface 1a of the structure 1 in a nuclear power reactor. The working head 33 is configured to provide inspection, repair, maintenance, cleaning or washing to the inspection target surface 1a of the structure 1 in a nuclear power reactor.

The positioning unit 32 includes a pair of running wheels 34, 34 for enabling the positioning unit 32 to travel, for example, in its width direction, a motor 36 for driving each running wheel 34, a pair of measurement wheels 35, 35 adapted to passively rotate while contacting with the inspection target surface 1a, a rotating meter 37 attached to each measurement wheel 35 and adapted to measure the number of revolutions of the measurement wheels 35, and a support wheel 38 for supporting the positioning unit 32 such that the remote operated vehicle 30 can be generally parallel to the inspection target surface 1a. Also provided in the positioning unit 32 are a pair of propellers 39, 39 for generating a pressing force for pressing the remote operated vehicle 30 itself against the inspection target surface 1a in the water and a rotating mechanism (not shown) for rotating each propeller 39.

The remote operated vehicle 30 having such a construction will be further described below.

When the remote operated vehicle 30 is in the vicinity of the inspection target surface 1a of the structure 1 in a nuclear power reactor, rotation of the pair of propellers 39, 39 of the remote operated vehicle 30 urges the instrument 30 to be pressed against the inspection target surface 1a. As a result, the pair of running wheels 34, 34, pair of measurement wheels 35, 35 and supporting wheels 38 are in contact with the inspection target surface 1a. In this state, the motor 36 drives each running wheel 34 to rotate, whereby the remote operated vehicle 30 can be moved, for example, in its width direction. At this time, each measurement wheel 35 which is in contact with the inspection target surface 1a is also rotated passively, and thus the number of revolution of the measurement wheel 35 can be measured by the rotating meter 37. In this way, the travel distance of the remote operated vehicle 30 on the inspection target surface 1a can be measured.

(Step of Positioning the Remote Operated Vehicle)

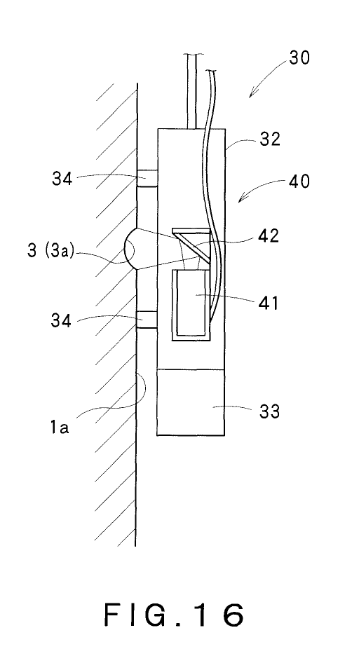

Next, a step of positioning the remote operated vehicle 30 is described with reference to FIGS. 16 to 19, in which the position of the remote operated vehicle 30 is determined by detecting the detection mark 3 comprising recessed portions 3a formed in the inspection target surface 1a, using a detection sensor 40 provided in the remote operated vehicle 30 during the travel of the instrument 30.

First, the construction of the detection sensor 40 of the remote operated vehicle 30 is described with reference to FIG. 16.

The detection sensor 40 is composed of any one or combination of ones selected from the group consisting, for example, of a television camera (photographic device) 41, an ultrasound distance sensor, a laser distance sensor, an ultrasonic testing equipments 43, an eddy current instrument and a mechanical contact switch, and is provided in the positioning unit 32. In this case, it is preferred that such a detection sensor 40 is provided in large numbers to be arranged in directions different from the direction in which the remote operated vehicle 30 is to be moved when it performs inspection or maintenance for the inspection target surface 1a. In this way, the detection range on the inspection target surface 1a by using these detection sensors 40 can be enlarged, thereby facilitating the detection for the recessed portions 3a.

Now, specific construction of each detection sensor 40 will be described below.

As shown in FIG. 16, in the case where a television camera 41 and a mirror 42 are provided in the positioning unit 32, an image of the detection mark 3 comprising recessed portion 3a formed in the inspection target surface 1a of the structure 1 in a nuclear power reactor is projected on the mirror 42, and the television camera 41 is configured to take the image of the detection mark 3 projected on the mirror 42. Thus, the detection mark 3 formed in the inspection target surface 1a can be detected, and then based on the detected information, each running wheel 34 can be driven and/or the level of the remote operated vehicle 30 can be adjusted. In this way, the positioning of the remote operated vehicle 30 can be performed.

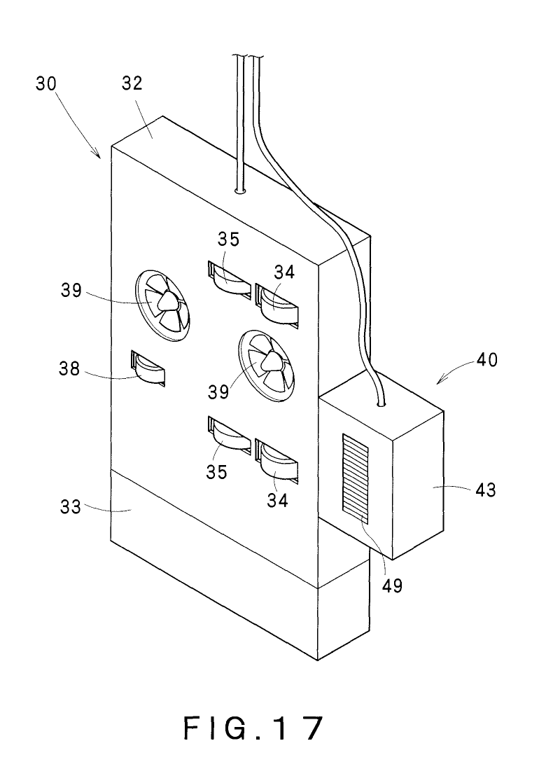

Next, the case where the detection sensor 40 provided in the positioning unit 32 is an ultrasonic testing equipments 43 is described with reference to FIG. 17. As shown in FIG. 17, the ultrasonic testing equipments 43 is attached at a side of a housing of the positioning unit 32, and a plurality of probe elements 49 are arranged in a layered state on the surface of the ultrasonic testing equipments 43. Due to such arrangement in a layered state of the plurality of probe elements 49, the detection mark 3 can be detected in a wider range of the inspection target surface 1a, and positional measurement becomes possible not only in the moving direction of the remote operated vehicle 30 but also in directions different therefrom.

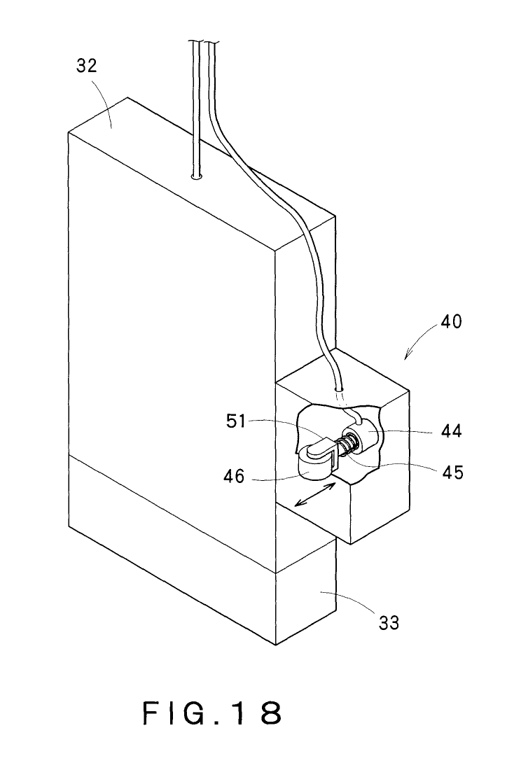

In addition, the case where the detection sensor 40 provided in the positioning unit 32 is a mechanical contact switch 44 is described with reference to FIG. 18. As shown in FIG. 18, the mechanical contact switch 44 is provided in a box which is attached at a side of a housing of the positioning unit 32. Attached to the mechanical contact switch 44 are a rotatable wheel 46 adapted to project forward and abut the inspection target surface 1a, and a pressing mechanism 51 comprising, for example, a spring which is adapted to press the wheel 46 against the inspection target surface 1a. When the wheel 46 is fitted in one of the recessed portions 3a while being pressed against the inspection target surface 1a due to the pressing mechanism 51 and running on the inspection target surface 1a, the change of the pressing force due to the pressing mechanism 51 can be detected by the mechanical contact switch 44, and hence the corresponding detection mark 3 comprising recessed portions 3a can be detected.

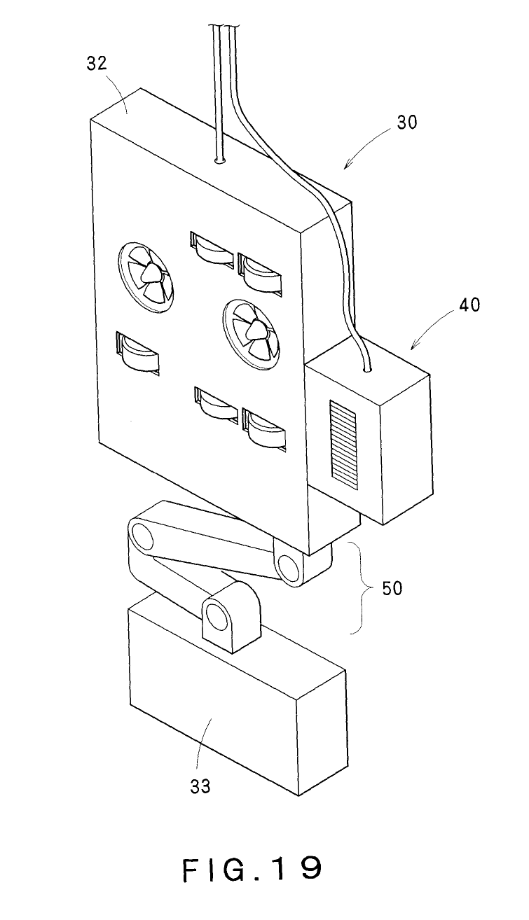

In FIGS. 15 through 18, while the construction in which the positioning unit 32 and the working head 33 are integrally connected with each other has been described, the positioning unit 32 and the working head 33 may be connected with each other via a driving mechanism 50, as shown in FIG. 19. The driving mechanism 50 has an arm-type structure such that the working head 33 can be optionally moved in the vertical direction and/or width direction relative to the positioning unit 32, as shown in FIG. 19. Such a driving mechanism 50 can be adapted to finely determine the position of the working head 33 relative to the positioning unit 32.

In the case of the remote operated vehicle 30 having this type of detection sensor 40, when it is moved, the detection mark 3 comprising recessed portions 3a formed in the inspection target surface 1a can be detected by the detection sensor 40, and based on the detection signal of the detection mark 3, the positioning of the remote operated vehicle 30 can be performed. Specifically, based on the moving distance and the moving direction on the inspection target surface 1a of the remote operated vehicle 30 as well as on the detection signal of the detection mark 3, positional confirmation for the remote operated vehicle 30 relative to the inspection target surface 1a is performed, while each of the running wheels 34 is driven such that the remote operated vehicle 30 can be moved to a desired position on the inspection target surface 1a.

(Operation)

As stated above, according to the method for inspection and maintenance of an inside of a nuclear power reactor, when inspection or maintenance for the inspection target surface 1a of the structure 1 in a nuclear power reactor is performed utilizing the remote operated vehicle 30, the detection mark 3 is formed in advance in the inspection target surface of the structure 1 in a nuclear power reactor prior to performing the inspection or maintenance in the nuclear power reactor using the remote operated vehicle 30. Thereafter, when actually performing the inspection or maintenance in the nuclear power reactor, the remote operated vehicle 30 is moved in the nuclear power reactor filled with water, and during this movement, the detection mark 3 formed in the inspection target surface 1a is detected by the detection sensor 40 of the remote operated vehicle 30, thereby determining the position of the remote operated vehicle 30. Therefore, since the positioning of the remote operated vehicle 30 can be performed utilizing the detection mark 3 formed in the inspection target surface 1a, as a landmark, the positioning of the remote operated vehicle 30 relative to the inspection target surface 1a in a nuclear power reactor can be performed in a shorter period of time with higher accuracy and the repeatability of positioning for the remote operated vehicle 30 can be more enhanced, as compared with the case where the detection mark 3 is not formed in the inspection target surface 1a.

(Modifications)

The method for inspection and maintenance of an inside of a nuclear power reactor according to this embodiment is not limited to the aspect as mentioned above, but various modifications can be added thereto.

For example, rather than forming the recessed portions 3a in the inspection target surface 1a by utilizing a notching, marking, punching or engraving process, a detection mark 4 may be formed by attaching attachment members 4a to the inspection target surface 1a, as shown in FIG. 20.

Specifically, during construction of a nuclear power reactor, patches are attached, in the air, to the inspection target surface 1a of a structure 1 in the nuclear power reactor at a factory thereof. Otherwise, welded cladding seats or welded beads 31b may be provided by applying a welding process to the inspection target surface. In this case, a machining process for finishing the shape of the welded portions is performed after the welding process. In this way, the patches 31a or welded beads 31b are formed into the detection mark 4 as shown in FIG. 20.

Such patches 31a, welded cladding seats or welded beads 31b are formed at a predetermined interval along, for example, the direction in which the welded portion 2 extends. At this time, if information concerning an absolute position of an inspection target site is needed, the distance from each patch 31a, welded cladding seat or welded bead 31bto a predetermined point (reference point) of the inspection target surface 1a is measured to determine the position to be processed. On the other hand, if only the repeatability of positioning relative to the inspection target site is required, the distance from each patch 31a, welded cladding seat or welded bead 31b to a predetermined point of the inspection target surface 1a is not needed to measure.

In the case where the welded cladding seats or welded beads 31b are formed in the inspection target surface 1a, as the detection sensor 40 provided in the remote operated vehicle 30, a ferrite scope 47 adapted to measure an amount of gamma ferrite in a welded portion can be used (see FIG. 21), other than those described above. As shown in FIG. 21, the ferrite scope 47 is provided in a box attached to a side of a housing of the positioning unit 32. To the ferrite scope 47, a cylinder piston 48 is attached for pushing the ferrite scope 47 toward the inspection target surface 1a. The detection of changes in the measurement amount of gamma ferrite in a welded portion by using the ferrite scope 47 enables detection of the detection mark 4 in the inspection target surface 1a.

Alternatively, in the method for inspection and maintenance of an inside of a nuclear power reactor according to this embodiment, the detection mark 3 or 4 may be detected by a television camera (photographic device) 52 which is provided separately from the remote operated vehicle 30, as shown in FIG. 22, rather than detecting the detection mark 3 or 4 by using the detection sensor 40 provided in the remote operated vehicle 30.

Specifically, during the positioning of the remote operated vehicle 30, the television camera 52 which is provided separately from the remote operated vehicle 30 can take an image of the detection mark 3 or 4 and the remote operated vehicle 30. Then, a worker can decide whether the remote operated vehicle 30 is at an inspection target position based on the position of remote operated vehicle 30 relative to the detection mark 3 or 4 in the image. If the remote operated vehicle 30 is not at the inspection target position, operation to move the remote operated vehicle 30 to a desired position is carried out. In such a manner, the positioning of the remote operated vehicle 30 can be performed.

### SECOND EMBODIMENT

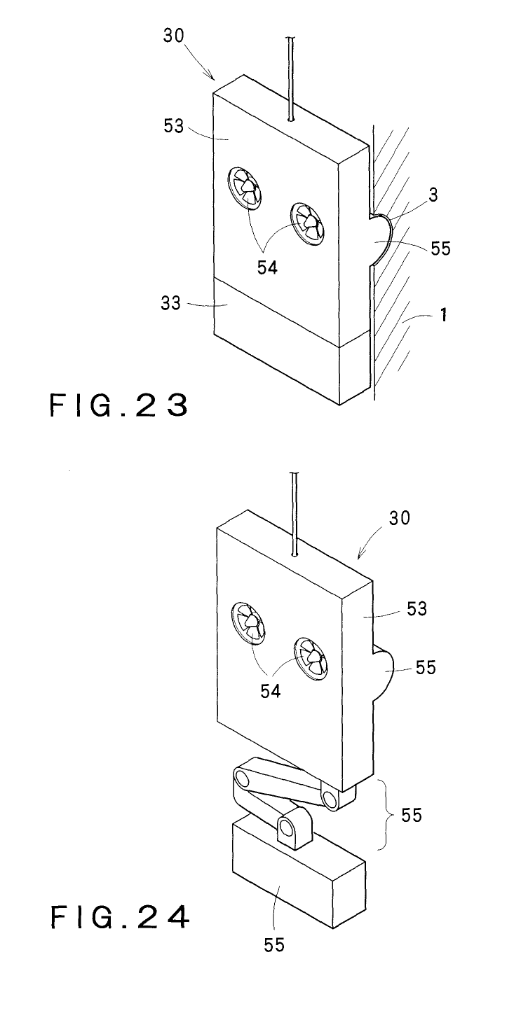

Hereinafter, a second embodiment of the present invention will be described with reference to the drawings. FIGS. 23 and 24 illustrate a method for inspection and maintenance of an inside of a nuclear power reactor according to the second embodiment of the present invention, respectively.

In the second embodiment shown in FIGS. 23 and 24, like parts in the first embodiment shown in FIGS. 1 through 19 are denoted by like reference numerals, respectively, and description of these parts will be omitted.

In the method for inspection and maintenance of an inside of a nuclear power reactor according to this embodiment, a projection 55 to be fitted in each recessed portion 3a is provided at the back surface (opposite to the inspection target surface 1a) of a positioning unit 53 of the remote operated vehicle 30, rather than providing the detection sensor 40 in the positioning unit 32 of the remote operated vehicle 30. The method of the second embodiment is different from the first embodiment shown in FIGS. 1 to 19 only in that the positioning of the remote operated vehicle 30 is performed by fitting the projection 55 into each recessed portion 3a in the inspection target surface 1a, and the other feature points in the construction are substantially the same as in the first embodiment.

First, in a step of forming the detection mark 3 in advance in the inspection target surface 1a of the structure 1 in a nuclear power reactor, semi-spherical recessed portions 6 each having an elliptic opening as shown in FIG. 3 or semi-spherical recessed portions 5 each having a circular opening as shown in FIG. 4 are formed as the detection mark 3 in the inspection target surface 1a of the structure 1 in a nuclear power reactor.

Next, a step of positioning the remote operated vehicle 30 is described. In this embodiment, as shown in FIG. 23, the projection 55 which can be adapted to fit in each of the aforementioned recessed portion 5 (or 6) is formed at the back surface of the positioning unit 53 of the remote operated vehicle 30. In the front surface of the positioning unit 53, a pair of propellers 54, 54 having substantially the same construction as that of the propellers 39 in the first embodiment are provided. By fitting the projection 55 of the positioning unit 53 into each recessed portion 5 (or 6) formed in the inspection target surface 1a, the positioning of the remote operated vehicle 30 can be performed.

The method for inspection and maintenance of an inside of a nuclear power reactor according to this embodiment is not limited to the aspect as mentioned above, but various modifications can be added thereto.

For example, rather than forming the recessed portions 3a in the inspection target surface 1a by providing a notching, marking, punching or engraving process, a detection mark 4 may be formed by attaching attachment members 4a or welded cladding seats to the inspection target surface 1a, as shown in FIG. 20.

In this case, rather than providing the projection 55, a recessed portion (not shown) adapted to receive each attachment member 4a or welded cladding seat is formed in the back surface of the positioning unit 53 of the remote operated vehicle 30. By fitting each attachment member 4a or welded cladding seat into the recessed portion of the positioning unit 53, the positioning of the remote operated vehicle 30 can be achieved.

In the underwater moving unit 30 of this embodiment, the positioning unit 53 and the working head 33 may be connected with each other via the driving mechanism 50 as shown in FIG. 24. The driving mechanism 50 has an arm-type structure such that the working head 33 can be optionally moved in the vertical direction and/or width direction with respect to the positioning unit 53, as shown in FIG. 24. Such a driving mechanism 50 can be adapted to finely determine the position of the working head 33 relative to the positioning unit 53.

### THIRD EMBODIMENT

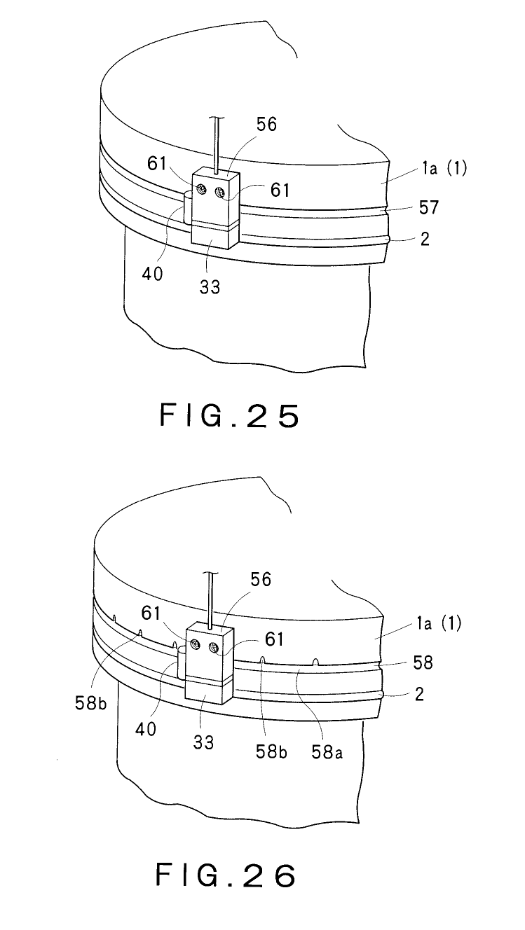

Now, a third embodiment of the present invention will be described with reference to the drawings. FIGS. 25 through 32 illustrate a method for inspection and maintenance of an inside of a nuclear power reactor of the third embodiment, respectively.

In the third embodiment shown in FIGS. 25 through 32, like parts in the first embodiment shown in FIGS. 1 through 19 are denoted by like reference numerals, respectively, and description of these parts will be omitted.

The method for inspection and maintenance of an inside of a nuclear power reactor according to this embodiment is different from the first embodiment shown in FIGS. 1 through 19 only in that the detection mark 3 is formed to extend linearly along the direction in which the remote operated vehicle 30 is to be moved when it performs inspection or maintenance of the inspection target surface, and the other feature points in the construction are substantially the same as in the first embodiment.

In general, as shown in FIG. 1, the welded portion 2 is formed into a horizontally extending toric form in the structure 1 in a nuclear power reactor, and hence the remote operated vehicle 30 is configured to move on the inspection target surface 1a along the direction in which the welded portion 2 extends. Namely, upon performing inspection or maintenance for the inspection target surface 1 by the remote operated vehicle 30, the remote operated vehicle 30 is often moved in the horizontal direction on the inspection target surface 1a.

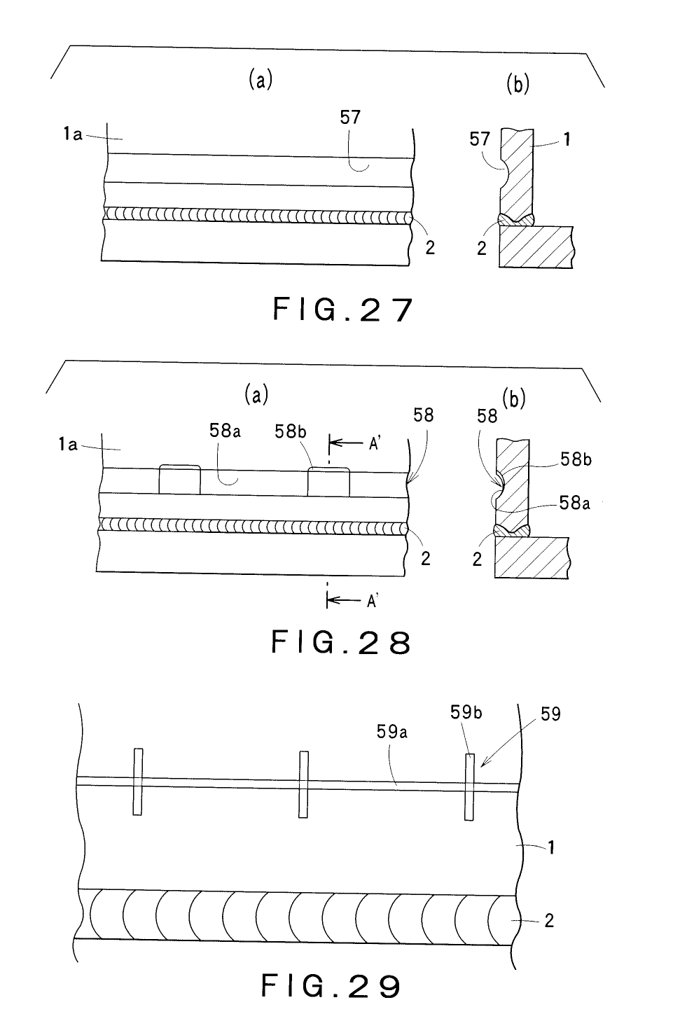

In the method for inspection and maintenance of an inside of a nuclear power reactor according to this embodiment, during a step of forming the detection mark 3 in advance in the inspection target surface 1a of the structure 1 in the nuclear power reactor, a recessed portion or groove 57 is formed in the inspection target surface 1a, which extends linearly and substantially parallel to the toric welded portion 2, as shown in FIGS. 25 and 27.

Namely, as shown in FIGS. 25 and 27, the recessed portion 57 extends linearly and horizontally and is formed into a toric shape, and the direction in which the recessed portion 57 extends is coincident with the direction in which the remote operated vehicle 30 is to be moved on the inspection target surface 1a when the remote operated vehicle 30 performs inspection or maintenance for the inspection target surface 1a. It is noted that the recessed portion 57 has a cross section of a semi-elliptic shape as shown in FIG. 27.

Furthermore, a recessed 58 portion having another construction which is formed in the step of forming the detection mark 3 in advance in the inspection target surface 1a of the structure 1 in a nuclear power reactor will be described, referring to FIGS. 26 and 28. While the recessed portion 58 extends linearly to be parallel to the toric welded portion 2 as in the case of recessed portion 57, discontinuous portions are formed at a predetermined interval therein. Specifically, as shown in FIGS. 26 and 28, the recessed portion 58 comprises a toric first recessed portion 58a extending linearly in the horizontal direction, and a plurality of second point-like recessed portions 58b provided at an equal interval along the direction in which the first recessed portion 58a extends. In a cross section as shown in FIG. 28(b), each second recessed portion 58b is substantially the same, in the depth, as the first recessed portion 58a, but is different, in the vertical width, from the first recessed portion 58a.

As an alternative construction of the recessed portion, one as shown in FIG. 29 can be mentioned. Such a recessed portion 59 shown in FIG. 29 comprises a toric first recessed portion 59a extending linearly in the horizontal direction, and a plurality of linear second recessed portions 59b arranged at an equal interval along the direction in which the first recessed portion 50a extends and provided to vertically intersect the first recessed portion 59a.

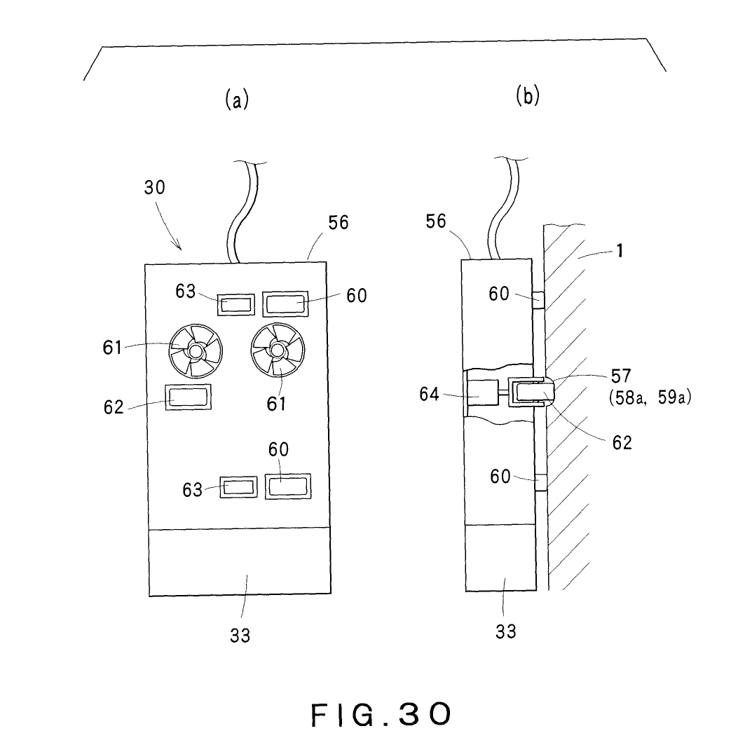

Next, a step of driving the remote operated vehicle 30 to move along the inspection target surface 1a will be described. In this embodiment, as shown in FIG. 30(a), a positioning unit 56 comprises a pair of propellers 61, 61, a pair of running wheels 60, 60, a pair of measurement wheels 63, 63, and a positioning wheel 62 which is attached to a cylinder piston 64 and configured to be pressed against the inspection target surface 1a by the effect of the cylinder piston 64. The positioning wheel 62, as shown in FIG. 30(b), is received in the recessed portion 57 (58a, 59a) of the detection mark 3, and thus the remote operated vehicle 30 can be guided along the direction in which the recessed portion 57 (58a, 59a) of the detection mark 3 extends.

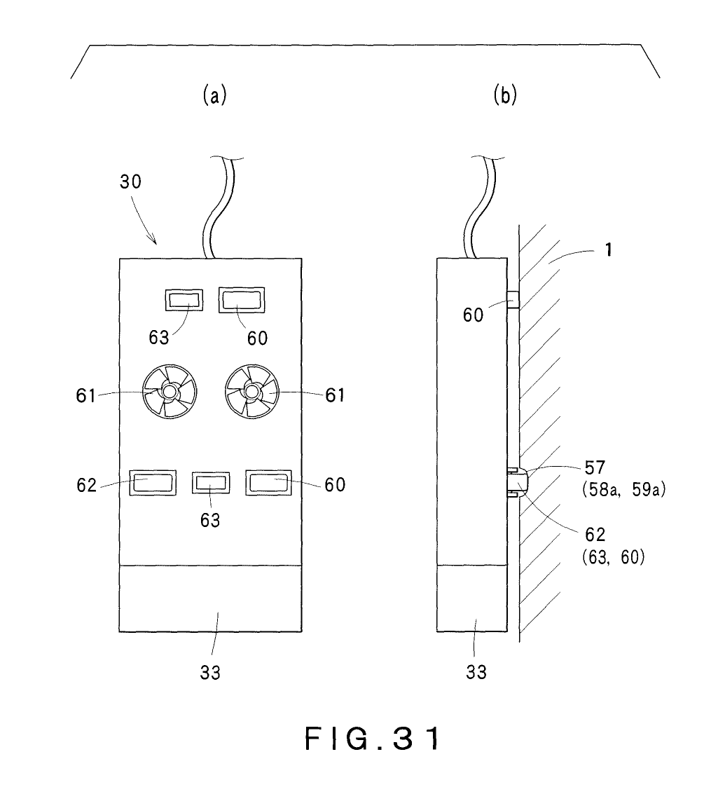

Another construction of the remote operated vehicle 30 used in this embodiment is then explained utilizing FIG. 31. As shown in FIG. 31(a), in this remote operated vehicle 30, one of the pair of running wheels 60, 60, one of the pair of measurement wheels 63, 63, and the positioning wheel 62 are provided such that they are arranged in a line along the width direction of the remote operated vehicle 30. The one of the pair of running wheels 60, 60, the one of the pair of measurement wheels 63, 63, and the positioning wheel 62 are all received in the recessed portion 57 (58a, 59a) of the detection mark 3 as shown in FIG. 31(b), and thus the remote operated vehicle 30 can be guided along the direction in which the recessed portion 57 (58a, 59b) of the detection mark 3 extends.

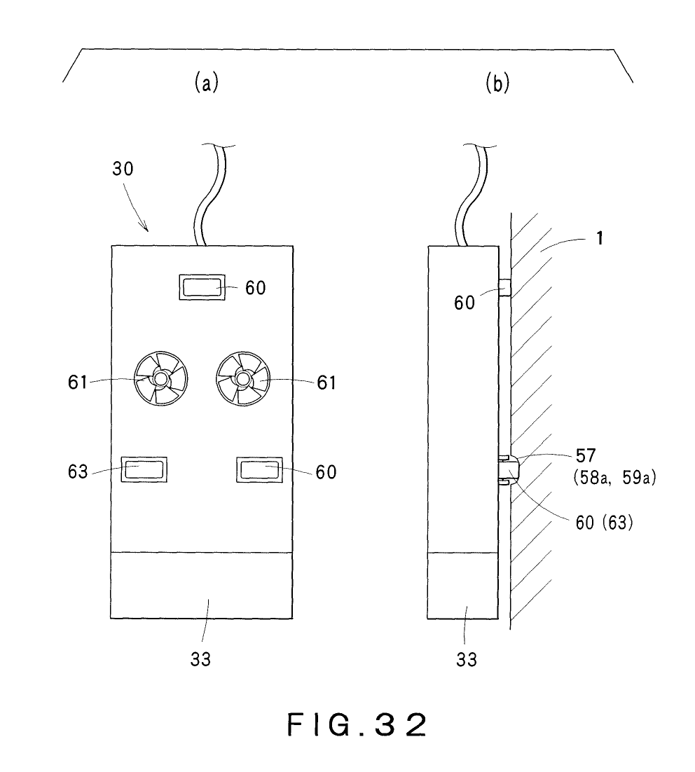

Further, still another construction of the remote operated vehicle 30 used in this embodiment is explained with reference to FIG. 32. As shown in FIG. 32(a), in this remote operated vehicle 30, while the positioning wheel 62 as shown in FIGS. 30 and 31 is not provided, one of the pair of running wheels 60, 60 and a measurement wheel 63 are provided such that they are arranged in a line along the width direction of the remote operated vehicle 30. The one of the pair of running wheels 60, 60 and the measurement wheel 63 are received in the recessed portion 57 (58a, 59a) of the detection mark 3 as shown in FIG. 32(b), and thus the remote operated vehicle 30 can be guided along the direction in which the recessed portion 57 (58a, 59b) of the detection mark 3 extends.

As stated above, the remote operated vehicle 30 is guided along the direction in which the recessed portion 57 (58a, 59b) of the detection mark 3 extends, whereby the positioning in the vertical direction of the remote operated vehicle 30 can be performed appropriately.

For example, as shown in FIG. 29, in the case where the recessed portion 59 comprises the first recessed portion 59a extending in the horizontal direction and second recessed portions 59b each extending in a direction different from the horizontal direction and where the remote operated vehicle 30 is moved in the horizontal direction along the direction in which the first recessed portion 59a extends, the accuracy of the positioning in the width direction of the remote operated vehicle 30 can be enhanced based on the detection information obtained by detecting each second recessed portion 59b provided at a predetermined interval such that it becomes vertical relative to the first recessed portion 59a. Similarly, in the case of the recessed portion 58 as shown in FIG. 26 and the remote operated vehicle 30 which is moved in the horizontal direction along the direction in which the first recessed portion 58a, the accuracy of the positioning in the width direction of the remote operated vehicle 30 can be enhanced based on the detection information obtained by detecting each point-like second recessed portion 58b provided at a predetermined interval.

In either the case of positioning the remote operated vehicle 30 by detecting the second recessed portion 58b or 59b, it is preferred to use a mechanical contact switch 44 as the detection sensor 40.

As described above, according to the method for inspection and maintenance of an inside of a nuclear power reactor of this embodiment, the detection mark 3 comprising the recessed portion 57 (58a, 59a) is formed to extend linearly along the direction in which the remote operated vehicle 30 is to be moved upon performing inspection or maintenance of the inspection target surface 1a, wherein the detection mark 3 is configured to guide the remote operated vehicle 30 upon performing inspection or maintenance of the inspection target surface 1a, whereby the positioning of the remote operated vehicle 30 can be performed more securely and accurately.

### FOURTH EMBODIMENT

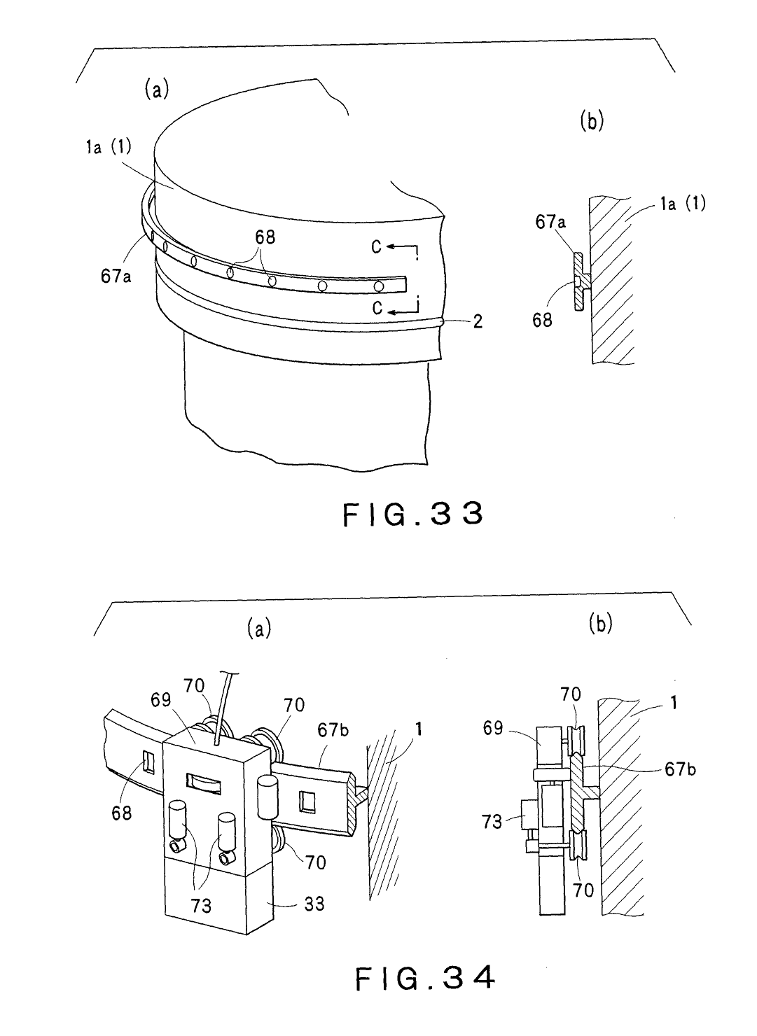

Hereinafter, a fourth embodiment according to the present invention will be described with reference to the drawings. FIGS. 33 and 34 show a method for inspection and maintenance of an inside of a nuclear power reactor of the fourth embodiment, respectively.

In the fourth embodiment shown in FIGS. 33 and 34, like parts in the first embodiment shown in FIGS. 1 through 19 are denoted by like reference numerals, respectively, and description of these parts will be omitted.

The method for inspection and maintenance of an inside of a nuclear power reactor of this embodiment is different from the first embodiment shown in FIGS. 1 to 19 only in that a toric rail 67a (67b) extending in parallel to the welded portion 2 is provided on the inspection target surface 1a so as to guide the remote operated vehicle 30 along this rail 67a (67b), and the other features in the construction are substantially the same as in the first embodiment.

As stated above, in the structure 1 in a nuclear power reactor, the welded portion 2 is of a toric shape extending in the horizontal direction, such that the remote operated vehicle 30 can be moved on the inspection target surface 1a along the direction in which the welded portion 2 extends. Namely, upon performing inspection or maintenance of the inspection target surface 1a of the remote operated vehicle 30, the remote operated vehicle 30 is often moved in the horizontal direction on the inspection target surface 1a.

In the method for inspection and maintenance of an inside of a nuclear power reactor of the this embodiment, before the step of forming the detection mark 3 in advance in the inspection target surface 1a of the structure 1 in a nuclear power reactor, the rail 67a extending in parallel to the toric welded portion 2 is formed by welding or cutting in the inspection target surface 1a of the structure 1 in a nuclear power reactor, as shown in FIG. 33, in a factory for the structure 1 in a nuclear power reactor.

Namely, as shown in FIG. 33, the rail 67a formed in advance on the inspection target surface 1a has a toric shape extending linearly in the horizontal direction, and the direction in which this rail 67a extends is coincident with the direction in which the remote operated vehicle 30 is to be moved on inspection target surface 1a upon performing inspection or maintenance of the inspection target surface 1a. The width of this rail 67a is substantially the same as the width of the running wheels 34 of the positioning unit 32 shown in FIG. 17.

Now, a rail 67b having another construction which is formed before the step of forming the detection mark in advance in the inspection target surface 1a of the structure 1 in a nuclear power reactor is described, referring to FIG. 34. In this rail 67b, the width in the vertical direction is much greater than that of the rail 67a shown in FIG. 33, and this width of the rail 67b is substantially the same as the height of a positioning unit 69.

Next, a step of forming the detection mark 3 is described. As shown in FIG. 33 (or FIG. 34), the detection mark 3 is formed by providing a plurality of recessed portions 68 at a predetermined interval in the rail 67a (67b) provided to the inspection target surface 1a.

Next, a step of driving the remote operated vehicle 30 to move along the inspection target surface 1a is described. In the case where the rail 67a as shown in FIG. 33 is provided to the inspection target surface 1a, the positioning unit 32 is designed in the remote operated vehicle 30, such that the running wheel 34 can travel on the rail 67a.

In the case where the rail 67b as shown in FIG. 34 is provided to the inspection target surface 1a, the positioning unit 69 is employed in the remote operated vehicle 30, which has right and left pairs (four in total) of wheels 70 in order to grasp the rail 67b from above and below. To the positioning unit 69, a cylinder piston (not shown) adapted to press this positioning unit 69 against the rail 67b is attached. Furthermore, in the positioning unit 69, a pair of cylinder pistons 73, 73, adapted to perform contact and detachment between the lower two wheels 70 of the four wheels 70 and the rail 72b, are provided. By driving these cylinder pistons 73, 73, contact and detachment of each wheel 70 relative to the rail 67b can be optionally effected.

In the positioning unit 69 as shown in FIG. 34, after hanging the unit 69 on the rail 67b, the contact and detachment of the wheels 70 relative to the rail 67b can be executed by remote operation of the cylinder pistons 73 to grasp and release the rail 67b therebetween. Thus, this unit 69 is effective, especially, in such a case that a worker cannot approach the inspection target area of the underwater inspection instrument 30 because it is too narrow, deep in water or to be irradiated with a radiation of high intensity.

As such, the remote operated vehicle 30 can be guided in the direction in which the rail 67a shown in FIG. 33 or rail 67b shown in FIG. 34 extends. Furthermore, since the remote operated vehicle 30 can be guided along the direction in which the rail 67a (67b) extends, the positioning in the vertical direction of the remote operated vehicle 30 can be performed appropriately.

Next, a step of detecting the detection mark 3 comprising recessed portion 68 formed in the rail 67a (67b) by using the detection sensor 40 of the remote operated vehicle 30 so as to determine the position of the remote operated vehicle 30 during its movement will be described.

In this embodiment, for example, as shown in FIG. 34, the positioning unit 69 of the remote operated vehicle 30 is guided along the rail 67b. During the movement of the remote operated vehicle 30 on the rail 67b, each of the recessed portions 68 provided at a predetermined interval in the rail 67b is detected by the detection sensor 40 provided in the remote operated vehicle 30, thereby performing the positioning of the remote operated vehicle 30.

As mentioned above, according to the method for inspection and maintenance of an inside of a nuclear power reactor of this embodiment, the rail 67a (67b) is formed to extend linearly along the direction in which the remote operated vehicle 30 is to be moved upon performing inspection or maintenance of the inspection target surface 1a, wherein the detection mark 3 is provided in the rail 67a (67b). In this case, since the remote operated vehicle 30 can be guided by the rail 67a (67b), the positioning of the remote operated vehicle 30 can be performed more securely and accurately.

### FIFTH EMBODIMENT

Now, a fifth embodiment will be described below. In the fifth embodiment, like parts in the first embodiment shown in FIGS. 1 through 22 are designated by like reference numerals, respectively, and thus description of these parts will be omitted.

The method for inspection and maintenance of an inside of a nuclear power reactor according to this embodiment is different from the first embodiment shown in FIGS. 1 to 22 only in that a detection mark (not shown) having a color different from the color of the inspection target surface 1a is coated on the inspection target surface 1a, rather than forming the detection mark 3 comprising recessed portions 3a or detection mark 4 comprising attachment members 4a, and the other features in the construction are substantially the same as in the first embodiment.

Namely, in the first embodiment, the structure 1 in a nuclear power reactor is formed of stainless steel and not coated with any material, while in the fifth embodiment, the structure 1 in a nuclear power reactor is coated with a proper material.

In this case, a detection mark is coated on the inspection target surface 1a, the color of the mark being different from that coated on the structure 1 in a nuclear power reactor.

It should be noted that the detection mark may be directly coated on the inspection target surface 1a, or as shown in FIG. 20, it may be formed by first attaching attachment members 4a, such as patches 31a, welded cladding seats or welded beads 31b onto the inspection target surface 1a, and then providing a coat on the attachment members 4a.

The coating of the detection mark is performed by a worker in the air during construction of a nuclear power reactor. Otherwise, if the nuclear power reactor has been operated and if temporary drainage of water is possible upon refueling outage for the nuclear power reactor, the coating is carried out by a worker in the air after the drainage. If such drainage is not possible, a diver should do the coating in the water.

In the coating of the detection mark, if information concerning an absolute position of each site to be inspected is needed, the distance from a fixed point (or reference point) in the inspection target surface 1a to each coating portion of the detection mark is measured to determine the coating position. On the other hand, if only the positioning repeatability relative to the inspection target surface is needed, there is no need to measure the distance from a fixed point of the inspection target 1a with respect to each coating portion of the detection mark.

In such a construction, while the remote operated vehicle 30 is moved in the nuclear power reactor filled with water, the coated detection mark is detected by the detection sensor 40 of the remote operated vehicle 30. Thus, based on the detected information, the position of the remote operated vehicle 30 can be determined so as to move the remote operated vehicle 30 to a desired inspection target position.

According to the method for inspection and maintenance of an inside of a nuclear power reactor as described above, since the positioning of the remote operated vehicle 30 can be performed utilizing such a detection mark coated on the inspection target surface 1a, as a landmark, which has a different color than that of the inspection target surface 1a, the positioning of the remote operated vehicle 30 relative to the inspection target surface 1a in a nuclear power reactor can be performed in a short period of time with high accuracy, and the positioning repeatability for the remote operated vehicle 30 can be significantly enhanced.

### SIXTH EMBODIMENT

Next, a sixth embodiment will be described below. In the sixth embodiment, like parts in the third embodiment shown in FIGS. 25 to 32 are denoted by like reference numerals, respectively, and thus description of these parts will be omitted.

The method for inspection and maintenance of an inside of a nuclear power reactor according to this embodiment is different from the third embodiment shown in FIGS. 25 to 32 only in that a detection mark (not shown) having a color different from the color of the inspection target surface 1a is coated on the recessed portions formed in the inspection target surface 1a, and the other features in the construction are substantially the same as in the third embodiment.

Namely, in the third embodiment, the structure 1 in a nuclear power reactor is formed of stainless steel and not coated with any material, while in this embodiment, the structure 1 in a nuclear power reactor is coated with a proper material.

In this embodiment, especially on the recessed portions 58 as shown in FIG. 26 or recessed portions 59 as shown in FIG. 29, a detection mark is formed by providing a coating with a color different from the coating color of the inspection target surface 1a.

In this way, while the remote operated vehicle 30 is moved in the nuclear power reactor filled with water along the recessed portions 58a or 59a, the coated detection mark is detected by the detection sensor 40 of the remote operated vehicle 30. Thus, based on the detected information, the position of the remote operated vehicle 30 can be determined so as to move the remote operated vehicle 30 to a desired inspection target position.

### SEVENTH EMBODIMENT

Finally, a seventh embodiment will be described below. In the seventh embodiment, like parts in the fourth embodiment shown in FIGS. 33 and 34 are denoted by like reference numerals, respectively, and thus description of these parts will be omitted.

The method for inspection and maintenance of an inside of a nuclear power reactor according to this embodiment is different from the fourth embodiment shown in FIGS. 33 and 34 only in that a detection mark (not shown) having a color different from the color of the inspection target surface 1a and rail 67a or 67b is coated on the rail 67a or 67b provided to the inspection target surface 1a, rather than forming the recessed portions 68 in the rail 67a or 67b, and the other features in the construction are substantially the same as in the fourth embodiment shown in FIGS. 33 and 34.

Namely, in the fourth embodiment, the structure 1 in a nuclear power reactor is formed of stainless steel and not coated with any material, while in this embodiment, the structure 1 in a nuclear power reactor is coated with a proper material.

In this embodiment, especially on the rail 67a as shown in FIG. 33 or rail 67b as shown in FIG. 34, a detection mark is formed by providing a coating with a color different from the coating color of the inspection target surface 1a or rail 67a, 67b at a predetermined interval.

In this way, during the movement of the remote operated vehicle 30 guided by the rail 67a, 67b in the nuclear power reactor filled with water, the coated detection mark is detected by the detection sensor 40 of the remote operated vehicle 30. Thus, based on the detected information, the position of the remote operated vehicle 30 can be determined so as to move the remote operated vehicle 30 to a desired inspection target position.

1. A method for inspection and maintenance of an inside of a nuclear power reactor, for performing inspection and maintenance for an inspection target surface in a nuclear power reactor, by using a remote operated vehicle, the method comprising the steps of:
forming a detection mark in advance by providing a notching, marking, punching or engraving process to the inspection target surface before performing inspection or maintenance of the inside of the nuclear power reactor by using the remote operated vehicle;
driving the remote operated vehicle to move in the nuclear power reactor filled with water; and
during the driving step of the remote operated vehicle, detecting the detection mark formed in the inspection target surface by using the remote operated vehicle so as to determine the position of the remote operated vehicle.

2. The method for inspection and maintenance of an inside of a nuclear power reactor according to claim 1, wherein, in the step of forming the detection mark in advance, the notching, marking, punching or engraving process is provided to the inspection target surface by using an electric discharging machine, cutting machine, grinding machine, laser processing machine, electrolytic processing machine, carving machine or vibrating pen; and the method further comprising the step of collecting secondary products to be produced during the above process.

3. A method for inspection and maintenance of an inside of a nuclear power reactor, for performing inspection and maintenance for an inspection target surface in a nuclear power reactor, by using a remote operated vehicle, the method comprising the steps of:
forming a detection mark in advance by attaching an attachment member to the inspection target surface before performing inspection or maintenance of the inside of the nuclear power reactor by using the remote operated vehicle;
driving the remote operated vehicle to move in the nuclear power reactor filled with water; and
during the driving step of the remote operated vehicle, detecting the detection mark formed in the inspection target surface by using the remote operated vehicle so as to determine the position of the remote operated vehicle.

4. The method for inspection and maintenance of an inside of a nuclear power reactor according to claim 3, wherein, in the step of forming the detection mark in advance, a welded bead is formed as the detection mark.

5. The method for inspection and maintenance of an inside of a nuclear power reactor according to claim 1, wherein, in the step of forming the detection mark in advance, the detection mark is formed such that it extends linearly along the direction in which the remote operated vehicle is to be moved when it performs inspection or maintenance for the inspection target surface.

6. The method for inspection and maintenance of an inside of a nuclear power reactor according to claim 3, wherein, in the step of forming the detection mark in advance, the detection mark is formed such that it extends linearly along the direction in which the remote operated vehicle is to be moved when it performs inspection or maintenance for the inspection target surface.

7. The method for inspection and maintenance of an inside of a nuclear power reactor according to claim 5, wherein the linearly extending detection mark has also a function to guide the remote operated vehicle when it performs inspection or maintenance for the inspection target surface in the nuclear power reactor.

8. The method for inspection and maintenance of an inside of a nuclear power reactor according to claim 6, wherein the linearly extending detection mark has also a function to guide the remote operated vehicle when it performs inspection or maintenance for the inspection target surface in the nuclear power reactor.

9. The method for inspection and maintenance of an inside of a nuclear power reactor according to claim 1, further comprising the step of:
after the step of forming the detection mark in advance, providing surface finish and/or remaining stress reduction in advance to the detection mark formed in the inspection target surface.

10. The method for inspection and maintenance of an inside of a nuclear power reactor according to claim 3, further comprising the step of:
after the step of forming the detection mark in advance, providing surface finish and/or remaining stress reduction in advance to the detection mark formed in the inspection target surface.

11. The method for inspection and maintenance of an inside of a nuclear power reactor according to claim 1, wherein
a detection sensor, composed of any one or combination of ones selected from the group consisting of a photographic device, an ultrasound distance sensor, a laser distance sensor, a ferrite scope, an ultrasonic testing equipments, an eddy current instrument and a mechanical contact switch, is provided in the remote operated vehicle; and
wherein the detection mark is detected by the detection sensor.

12. The method for inspection and maintenance of an inside of a nuclear power reactor according to claim 3, wherein
a detection sensor, composed of any one or combination of ones selected from the group consisting of a photographic device, an ultrasound distance sensor, a laser distance sensor, a ferrite scope, an ultrasonic testing equipments, an eddy current instrument and a mechanical contact switch, is provided in the remote operated vehicle; and
wherein the detection mark is detected by the detection sensor.

13. The method for inspection and maintenance of an inside of a nuclear power reactor according to claim 1, wherein the position of the remote operated vehicle is determined by:
forming the detection mark, in the step of forming the detection mark in advance, the detection mark comprising a first detection mark portion extending along the direction in which the remote operated vehicle is to be moved when it performs inspection or maintenance for the inspection target surface, and a second detection mark portion which is different in shape and extending direction from those of the first detection mark portion; and
detecting the second detection mark portion by using the remote operated vehicle moving in the direction in which the first detection mark portion extends when the remote operated vehicle performs inspection or maintenance for the inspection target surface.

14. The method for inspection and maintenance of an inside of a nuclear power reactor according to claim 3, wherein the position of the remote operated vehicle is determined by:
forming the detection mark, in the step of forming the detection mark in advance, the detection mark comprising a first detection mark portion extending along the direction in which the remote operated vehicle is to be moved when it performs inspection or maintenance for the inspection target surface, and a second detection mark portion which is different in shape and extending direction from those of the first detection mark portion; and
detecting the second detection mark portion by using the remote operated vehicle moving in the direction in which the first detection mark portion extends when the remote operated vehicle performs inspection or maintenance for the inspection target surface.

15. The method for inspection and maintenance of an inside of a nuclear power reactor according to claim 11, wherein the detection sensor is provided in large numbers to be arranged in directions different from the direction in which the remote operated vehicle is to be moved when it performs inspection or maintenance for the inspection target surface.

16. The method for inspection and maintenance of an inside of a nuclear power reactor according to claim 12, wherein the detection sensor is provided in large numbers to be arranged in directions different from the direction in which the remote operated vehicle is to be moved when it performs inspection or maintenance for the inspection target surface.

17. A method for inspection and maintenance of an inside of a nuclear power reactor, for performing inspection and maintenance for an inspection target surface in a nuclear power reactor, by using a remote operated vehicle, the method comprising the steps of:
forming a detection mark in advance by providing a notching, marking, punching or engraving process to the inspection target surface before performing inspection or maintenance of the inside of the nuclear power reactor by using the remote operated vehicle;
driving the remote operated vehicle to move in the nuclear power reactor filled with water; and
during the driving step of the remote operated vehicle, detecting the detection mark formed in the inspection target surface by using a photographic device provided separately from the remote operated vehicle so as to determine the position of the remote operated vehicle.
